(19) United States
(12) Patent Application Publication
(10) Pub. No.: US 2025/0338317 A1
(43) Pub. Date: Oct. 30, 2025

(54) TERMINAL, RADIO COMMUNICATION METHOD, AND BASE STATION

(71) Applicant: NTT DOCOMO, INC., Tokyo (JP)

(72) Inventors: Naoya SHIBAIKE, Tokyo (JP); Yuki MATSUMURA, Tokyo (JP); Satoshi NAGATA, Tokyo (JP); Qiping PI, Beijing (CN); Jing WANG, Beijing (CN); Lan CHEN, Beijing (CN); Yiyi LU, Beijing (CN); Yong LI, Beijing (CN)

(73) Assignee: NTT DOCOMO, INC., Tokyo (JP)

(21) Appl. No.: 18/867,213

(22) PCT Filed: May 20, 2022
(86) PCT No.: PCT/JP2022/020973

§ 371 Date: Nov. 19, 2024

(51) Int. Cl. H04W 74/0833; H04W 52/18

(52) U.S. Cl. CPC H04W 74/0833; H04W 52/18

(57) ABSTRACT

A terminal according to one aspect of the present disclosure includes a control section that determines a plurality of groups including a plurality of resources for a physical random access channel, and determines transmission power for each of the plurality of resources by using one or more counters, and a transmitting section that transmits a plurality of repetitions of the physical random access channel in the plurality of resources. According to one aspect of the present disclosure, a coverage of a random access procedure can be improved.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

Improvements in coverage are under consideration for future radio communication systems (for example, NR).

However, the random access procedure for improving coverage is not clear. If the random access procedure is not clear, communication throughput may decrease.

In view of this, an object of the present disclosure is to provide a terminal, a radio communication method, and a base station that improve the coverage of the random access procedure.

### Solution to Problem

A terminal according to one aspect of the present disclosure includes a control section that determines a plurality of groups including a plurality of resources for a physical random access channel, and determines transmission power for each of the plurality of resources by using one or more counters, and a transmitting section that transmits a plurality of repetitions of the physical random access channel in the plurality of resources.

### Advantageous Effects of Invention

An aspect of the present disclosure achieves an improvement in the coverage of the random access procedure.

### BRIEF DESCRIPTION OF DRAWINGS

FIG. 1 shows an example of operation of a power ramping counter among a plurality of preambles using the same beam.

FIG. 2 shows an example of operations of a power ramping counter among a plurality of preambles using different beams.

FIG. 3 shows an example of operations after transmission of an RA preamble.

FIGS. 4A and 4B show examples of multi-PRACH transmission.

FIGS. 5A to 5C show examples of Type 1 multi-PRACH transmission.

FIGS. 6A to 6C show examples of Type 2 multi-PRACH transmission.

FIG. 7 shows an example of associations between RO and SSB indices.

FIG. 8 shows an example of Case 1-1 of Embodiment #1/Choice 1/Option 1.

FIG. 9 shows an example of Case 1-1 of Embodiment #1/Choice 1/Option 2.

FIG. 10 shows another example of Case 1-1 of Embodiment #1/Choice 1/Option 2.

FIG. 11 shows an example of Case 1-2 of Embodiment #1/Choice 1/Option 1.

FIG. 12 shows an example of Case 1-2 of Embodiment #1/Choice 1/Option 2.

FIG. 13 shows another example of Case 1-2 of Embodiment #1/Choice 1/Option 2.

FIG. 14 shows an example of Case 1-3 of Embodiment #1/Choice 1/Option 1.

FIG. 15 shows an example of Case 1-3 of Embodiment #1/Choice 1/Option 2.

FIG. 16 shows another example of Case 1-3 of Embodiment #1/Choice 1/Option 2.

FIG. 17 shows an example of one RO group for Case 2-1 of Embodiment #1/Choice 1/Option 1.

FIG. 18 shows an example of two RO groups for Case 2-1 of Embodiment #1/Choice 1/Option 1.

FIG. 19 shows another example of two RO groups for Case 2-1 of Embodiment #1/Choice 1/Option 1.

FIG. 20 shows an example of one RO group for Case 2-2 of Embodiment #1/Choice 1/Option 1.

FIG. 21 shows an example of two RO groups for Case 2-2 of Embodiment #1/Choice 1/Option 1.

FIG. 22 shows another example of two RO groups for Case 2-2 of Embodiment #1/Choice 1/Option 1.

FIG. 23 shows an example of one RO group for Case 2-3 of Embodiment #1/Choice 1/Option 1.

FIG. 24 shows an example of two RO groups for Case 2-3 of Embodiment #1/Choice 1/Option 1.

FIG. 25 shows another example of two RO groups for Case 2-3 of Embodiment #1/Choice 1/Option 1.

FIG. 26 shows an example of Case 1-1 of Embodiment #1/Choice 2.

FIG. 27 shows an example of Case 1-2 of Embodiment #1/Choice 2.

FIG. 28 shows an example of Case 1-3 of Embodiment #1/Choice 2.

FIG. 29 shows an example of Case 2-1 of Embodiment #1/Choice 2.

FIG. 30 shows an example of Case 2-2 of Embodiment #1/Choice 2.

FIG. 31 shows an example of Case 2-3 of Embodiment #1/Choice 2.

FIG. 32 is a diagram showing an example of a schematic configuration of a radio communication system according to an embodiment.

FIG. 33 is a diagram showing an example of a configuration of a base station according to an embodiment.

FIG. 34 is a diagram showing an example of a configuration of a user terminal according to an embodiment.

FIG. 35 is a diagram showing an example of a hardware configuration of a base station and a user terminal according to an embodiment.

FIG. 36 is a diagram showing an example of a vehicle according to an embodiment.

### DESCRIPTION OF EMBODIMENTS

### (TCI, Spatial Relation, QCL)

Considered in NR is controlling the reception processing (for example, at least one of reception, demapping, demodulation, and decoding) and the transmission processing (for example, at least one of transmission, mapping, precoding, modulation, and encoding) of at least one of a signal and a channel (expressed as signal/channel) in a UE, based on a Transmission Configuration Indication state (TCI state).

The TCI state may represent those applied to a downlink signal/channel. The equivalent of the TCI state applied to an uplink signal/channel may be expressed as spatial relation.

The TCI state is information about the Quasi-Co-Location (QCL) of a signal/channel, and may be called a spatial reception parameter, Spatial Relation Information, or the like. The TCI state may be configured in the UE for each channel or each signal.

The QCL is an index indicating a statistical property of a signal/channel. For example, when a signal/channel has a QCL relation with another signal/channel, this may mean that it can be assumed that at least one of a Doppler shift, a Doppler spread, an average delay, a delay spread, and a spatial parameter (for example, a spatial reception parameter (spatial Rx parameter)) is the same between a plurality of these different signals/channels (that is, the QCL is applied to at least one of these).

Note that the spatial reception parameter may correspond to a reception beam (for example, a reception analog beam) of the UE, and the beam may be specified based on a spatial QCL. The QCL (or at least one element of the QCL) in the present disclosure may be read as an sQCL (spatial QCL).

A plurality of types (QCL types) of QCL may be defined. For example, four QCL types A to D may be provided, each of which has different parameters (or parameter sets) that can be assumed to be identical. The parameters (which may be called QCL parameters) are as follows:
QCL Type A (QCL-A): Doppler shift, Doppler spread, average delay and delay spread
QCL Type B (QCL-B): Doppler shift and Doppler spread
QCL Type C (QCL-C): Doppler shift and average delay
QCL Type D (QCL-D): Spatial reception parameter.

The UE's assumption that a Control Resource Set (CORESET), a channel, or a reference signal is in a particular QCL (for example, QCL type D) relation with another CORESET, a channel, or a reference signal may be referred to as a QCL assumption.

The UE may determine at least one of a transmission beam (Tx beam) and a reception beam (Rx beam) for a signal/channel based on the TCI state or the QCL assumption of the signal/channel.

The TCI state may be information about the QCL between the target channel (in other words, the Reference Signal (RS) for that channel) and another signal (for example, another RS), for example. The TCI state may be configured (specified) by higher layer signaling, physical layer signaling, or a combination of both.

The physical layer signaling may be, Downlink Control Information (DCI), for example.

The channel for which the TCI state or spatial relation is configured (specified) may be at least one of a downlink shared channel (Physical Downlink Shared Channel (PDSCH)), a downlink control channel (Physical Downlink Control Channel (PDCCH)), an uplink shared channel (Physical Uplink Shared Channel (PUSCH)), and an uplink control channel (Physical Uplink Control Channel (PUCCH)), for example.

The RS that has a QCL relation with the channel may be at least one of a Synchronization Signal Block (SSB), a Channel State Information Reference Signal (CSI-RS), a Sounding Reference Signal (SRS), a tracking CSI-RS (also called Tracking Reference Signal (TRS)), and a QCL detection reference signal (also called QRS), for example.

The SSB is a signal block including at least one of a Primary Synchronization Signal (PSS), a Secondary Synchronization Signal (SSS), and a broadcast channel (Physical Broadcast Channel (PBCH)). The SSB may also be called SS/PBCH block.

An RS of QCL type X in the TCI state may mean an RS that has a QCL type X relation with a certain channel/signal (its DMRS), and this RS may be called a QCL source of QCL type X in the TCI state.

### (Initial Access Procedure)

In the initial access procedure, the UE (in RRC IDLE mode) receives an SS/PBCH block (SSB), transmits Msg. 1 (PRACH/random access preamble/preamble), receives Msg. 2 (PDCCH, PDSCH including random access response (RAR)), transmits Msg. 3 (PUSCH scheduled by RAR UL grant), and receives Msg. 4 (PDCCH, PDSCH including UE contention resolution identity). After that, when the base station (network) transmits an ACK to Msg. 4 from the UE, the RRC connection is established (RRC CONNECTED mode).

The reception of SSB includes PSS detection, SSS detection, PBCH-DMRS detection, and PBCH reception. The PSS detection includes detection of part of a physical cell ID (PCI), detection (synchronization) of OFDM symbol timing, and (coarse) frequency synchronization. The SSS detection includes detection of the physical cell ID. The PBCH-DMRS detection includes detection of (part of) the SSB index in a half radio frame (5 ms). The PBCH reception includes detection of a system frame number (SFN) and radio frame timing (SSB index), reception of configuration information for remaining minimum system information (RMSI, SIB1) reception, and recognition of whether the UE can camp on the cell (carrier).

The SSB has a bandwidth of 20 RB and a time of 4 symbols. The transmission period of the SSB can be configured from among {5, 10, 20, 40, 80, 160} ms. In the half frame, a plurality of symbol positions of the SSB is defined based on the frequency range (FR1, FR2).

The PBCH has a payload of 56 bits. N repetitions of the PBCH are transmitted within a period of 80 ms, where N depends on the SSB transmission period.

The system information is constituted of MIB, RMSI (SIB1), and other system information (OSI) carried by the PBCH. The SIB1 includes information for RACH configuration and RACH procedures. The time/frequency resource relation between the SSB and the PDCCH monitoring resource for SIB1 is set by the PBCH.

A base station using beam correspondence transmits a plurality of SSBs using a plurality of beams for each SSB transmission period. The plurality of SSBs each has a plurality of SSB indices. Upon detection of one SSB, the UE transmits a PRACH on a RACH occasion associated with the SSB index and receives an RAR in an RAR window.

### (Beam and Coverage)

In high frequency bands, if beamforming is not applied to the synchronization signal/reference signal, the coverage will be narrow and it will be difficult for the UE to find the base station. On the other hand, if beamforming is applied to the synchronization signal/reference signal to ensure coverage, a strong signal will reach in a specific direction, but the signal will be even more difficult to reach in other directions. If the direction in which the UE exists is unknown in the base station before the UE is connected, it is impossible to transmit the synchronization signal/reference signal using a beam only in the appropriate direction. The base station may transmit a plurality of synchronization signals/reference signals having beams in different directions, and the UE may recognize which beam it has found. If thin (narrow) beams are used for coverage, it is necessary to transmit many synchronization signals/reference signals, which may increase overhead and reduce frequency utilization efficiency.

In order to decrease the number of beams (synchronization signals/reference signals) and suppress the overhead, using thicker (wider) beams results in narrower coverage.

In future radio communication systems (for example, 6G), it is expected that frequency bands such as millimeter waves and terahertz waves will be used more widely. It is thus expected that communication services will be provided by constructing cell areas/coverages using many thin beams.

The existing FR2 may be used to expand the service area, or a higher frequency band than the existing FR2 may be used. To achieve these, it is preferable to improve beam management in addition to multi-TRP, reconfigurable intelligent surface (RIS), and the like.

Coverage extensions are considered, including PRACH extensions for frequency range (FR) 2. For example, PRACH repetition using the same beam or a plurality of different beams is under consideration. This PRACH extension may be applied to FR1.

The PRACH extension may be applied to the short PRACH format or to other formats.

The common RACH configuration (RACH-ConfigCommon) may include a generic RACH configuration (rach-ConfigGeneric), a total number of RA preambles (totalNumberOfRA-Preambles), and SSB per RACH occasion and contention-based (CB) preambles per SSB (ssb-perRACH-OccasionAndCB-PreamblesPerSSB). rach-ConfigGeneric may include a PRACH configuration index (prach-ConfigurationIndex) and a message 1 FDM (msg1-FDM, the number of PRACH occasions subjected to FDM in one time instance). ssb-perRACH-OccasionAndCB-PreamblesPerSSB may include the number of CB preambles per SSB for ⅛ SSBs per RACH occasion (oneEighth, one SSB associated with 8 RACH occasions).

For a Type 1 random access procedure (four-step random access procedure, messages 1/2/3/4), the UE may specify the number N of SS/PBCH blocks associated with one PRACH occasion and the number R of CB preambles per SS/PBCH block per valid PRACH occasion via ssb-perRACH-OccasionAndCB-PreamblesPerSSB.

For the Type 1 random access procedure or for a Type 2 random access procedure (two-step random access procedure, messages A/B) with configuration of PRACH occasions independent of the Type 1 random access procedure, if N<1, one SS/PBCH block is mapped to 1/N consecutive valid RACH occasions, and for each valid PRACH occasion, R CB preambles with consecutive indices associated with SS/PBCH block index start from preamble index 0. If N>=1, for each valid PRACH occasion, R CB preambles with consecutive indices associated with SS/PBCH block index n (0<=n<−N−1) start from preamble index n·N_preamble\hat{ }total/N. In this case, N_preamble\hat{ }total is given by totalNumberOfRA-Preambles for the Type 1 random access procedure, and is given by msgA-TotalNumberOfRA-Preambles for the Type 2 random access procedure with configuration of PRACH occasions independent of the Type 1 random access procedure. N_preamble total is a multiple of N.

Starting from frame 0, the association period for mapping the SS/PBCH blocks to the PRACH occasions is the minimum value in the set that is determined by the PRACH configuration period according to the relation (relation defined in the specification) between the PRACH configuration period and the association period (number of PRACH configuration periods) such that N_Tx\hat{ }SSB SS/PBCH block indices are mapped to the PRACH occasions at least once in the association period. The UE derives N_Tx\hat{ }SSB from the value of SSB positions in burst (ssb-PositionsInBurst) in SIB1 or in the common serving cell configuration (ServingCellConfigCommon). If there is a set of PRACH occasions or PRACH preambles that are not mapped to N_Tx\hat{ }SSB SS/PBCH block indices after an integer number of mapping cycles from the SS/PBCH block indices to the PRACH occasions within the association period, then no SS/PBCH block index is mapped to that set of PRACH occasions or PRACH preambles. An association pattern period includes one or more association periods and is determined such that the pattern between the PRACH occasions and the SS/PBCH block indices repeats at most every 160 ms. If there is a PRACH occasion that is not associated with a SS/PBCH block index after an integer number of association periods, then that PRACH occasion is not used for PRACH.

For the PRACH configuration periods of 10, 20, 40, 80, and 160 [msec], the association periods are {1, 2, 4, 8, 16}, {1, 2, 4, 8}, {1, 2, 4}, {1, 2}, and {1}, respectively.

For PRACH occasion (RACH occasion (RO)) and beam (SSB/CSI-RS) association, if ssb-perRACH-OccasionAndCB-PreamblesPerSSB indicates oneHalf,n16 (N=½, R=16) and msg1-FDM is 4, then 4 ROs are subjected to FDM in one time instance and one SSB is mapped to two ROs. Preamble indices 0 to 15 are associated with two ROs and preamble indices 0 to 15 are associated with SSOB. Thus, when N<1, one SSB is mapped to a plurality of ROs. This increases the RO capacity per beam.

If ssb-perRACH-OccasionAndCB-PreamblesPerSSB indicates n4,n16 (N=4, R=16), msg1-FDM is 4, and N_preamble\hat{ }total is 64, then 4 ROs are subjected to FDM in one time instance, and 4 SSBs are mapped to one RO. SSB0 to 3 are associated with one RO. SSB0 is associated with preamble indices 0 to 15, SSB1 is associated with preamble indices 15 to 31, SSB2 is associated with preamble indices 32 to 47, and SSB3 is associated with preamble indices 48 to 63. In this way, the same RO is associated with different SS/PBCH block indices, and different preambles use different SS/PBCH block indices. The base station can distinguish the associated SS/PBCH block indices according to the received PRACH.

The random access preamble can only be transmitted in time resources specified in the random access configuration of the specification, depending on FR1 or FR2 and the spectrum type (paired spectrum/supplementary uplink (SUL)/unpaired spectrum). The PRACH configuration index is given by the higher layer parameter prach-ConfigurationIndex or by msgA-PRACH-ConfigurationIndex if configured. In the specification, each value of the PRACH configuration index is associated with at least one of the following: preamble format, x and y in n_f (frame number) mod x=y, subframe number, starting symbol, number of PRACH slots in the subframe, number of time domain PRACH occasions in the PRACH slot N_t\hat{ }RA, slot, and PRACH duration N_dur\hat{ }RA.

The type of RACH procedure triggered is different for different purposes such as whether PRACH repetition is applicable to a scenario. The type of RACH procedure may be at least one of the following:
contention-free random access (CFRA), PDCCH ordered RA (RA initiated by a PDCCH order), CFRA for beam failure recovery (BFR), CFRA for system information (SI) request, CFRA for reconfiguration with sync, and the like
contention-based random access (CBRA), RA triggered by MAC entity, RA triggered by RRC with event, CBRA for BFR, and the like
Four-step RACH
Two-step RACH.

However, the configuration/procedure of PRACH repetition is not clear. For example, it is not clear how the PRACH resource for repetition (for example, repetition pattern, number of repetitions) is configured, the UE operation of preamble repetition transmission, the influence on the counter/timer related to RACH, and the like. If such configuration/procedure is not clear, there is a possibility of degradation of communication quality/communication throughput.

### (RA Response Window)

An RA response window (ra-ResponseWindow) is a time window for monitoring the RA response (RAR) (SpCell only). An RA contention resolution timer (ra-ContentionResolutionTimer) is a timer for RA contention resolution (SpCell only). An Msg. B response window is a time window for monitoring the RA response (RAR) for two-step RA type (SpCell only).

Once the RA preamble has been transmitted, the MAC entity performs the following operations 1 to 3, regardless of whether a measurement gap may occur.

### [Operation 1]

If a contention-free RA preamble for a BFR request is transmitted by the MAC entity, the MAC entity performs the following operations 1-1 and 1-2.

[[Operation 1-1]] The MAC entity starts ra-ResponseWindow set in the BFR configuration (BeamFailureRecoveryConfig) on the first PDCCH occasion from the end of the RA preamble transmission.
[[Operation 1-2]] The MAC entity monitors PDCCH transmissions in the search space indicated by the BFR search space ID (recoverySearchSpaceId) of the SpCell identified by the C-radio network temporary identifier (RNTI) while ra-ResponseWindow is running.

### [Operation 2]

Otherwise, the MAC entity performs the following operations 2-1 and 2-2.

[[Operation 2-1]] The MAC entity starts ra-ResponseWindow configured in the common RACH configuration (RACH-ConfigCommon) on the first PDCCH occasion after the end of the RA preamble transmission.
[[Operation 2-2]] The MAC entity monitors the PDCCH transmission of the SpCell for the RAR identified by the RA-RNTI while ra-ResponseWindow is running.

### [Operation 3]

If ra-ResponseWindow configured in BeamFailureRecoveryConfig expires and a PDCCH transmission on the search space indicated by recoverySearchSpaceId addressed to the C-RNTI is received on the serving cell on which the preamble was transmitted, or if ra-ResponseWindow configured in RACH-ConfigCommon expires and an RAR is received containing RA preamble identifiers matching the transmitted preamble index (PREAMBLE INDEX), the MAC entity considers the RAR reception as a failure and increments the preamble transmission counter (PREAMBLE TRANSMISSION COUNTER) by 1.

The MAC entity may stop ra-ResponseWindow (may stop monitoring for RARs) after successful reception of an RAR including RA preamble identifiers matching the transmitted PREAMBLE INDEX.

There are two cases for PDCCH monitoring in the RA response window: PDCCH for the base station's response to the BFR and PDCCH for RAR. The following may apply to both the cases.

Once the MSGA (Msg. A) preamble has been transmitted, the MAC entity performs the following operations 4 to 6, regardless of whether a measurement gap may occur.

### [Operation 4]

The MAC entity starts an Msg. B response window (msgB-ResponseWindow) in the PDCCH monitoring window prescribed in the specification.

msgB-ResponseWindow may start at the first symbol of the earliest CORESET for which the UE is configured to receive PDCCH for a Type 1-PDCCH CSS set that is at least one symbol after the last symbol of the PRACH occasion corresponding to the PRACH transmission. The length of msgB-ResponseWindow may correspond to the SCS for the Type 1-PDCCH CSS set.

### [Operation 5]

The MAC entity monitors the PDCCH transmission of the SpCell for the RAR identified by the MSGB-RNTI while msgB-ResponseWindow is running.

### [Operation 6]

If C-RNTI MAC CE is included in the MSGA, the MAC entity monitors the PDCCH transmission of the SpCell for the RAR identified by the C-RNTI while msgB-ResponseWindow is running.

The RA-RNTI associated with the PRACH occasion on which the RA preamble is transmitted is calculated as follows:

$$RA - RNTI = 1 + s\_id + 14 \times t\_id + 14 \times 80 \times f\_id + 14 \times 80 \times 8 \times ul\_carrier \_id$$

In the above equation, s_id is the index of the first OFDM symbol of the PRACH occasion (0<=s_id<14). t_id is the index of the first slot of the PRACH occasion in the system frame (0<=t_id<80). The subcarrier spacing (SCS) for the determination of t_id is based on the value of μ. f_id is the index of the PRACH occasion in the frequency domain (0<=f_id<8). ul_carrier_id is the UL carrier used for RA preamble transmission (0 for normal uplink (NUL) carrier, 1 for supplementary uplink (SUL) carrier). The RA-RNTI is calculated according to the specification. The RA-RNTI is the RNTI for four-step RACH.

The MSGB-RNTI associated with the PRACH occasion on which the RA preamble is transmitted is calculated as follows:

$$MSGB - RNTI = 1 + s\_id + 14 \times t\_id + 14 \times 80 \times f\_id + 14 \times 80 \times 8 \times ul\_carrier \_id + 14 \times 80 \times 8 \times 2$$

In the above equation, s_id is the index of the first OFDM symbol of the PRACH occasion (0<=s_id<14). t_id is the index of the first slot of the PRACH occasion in the system frame (0<=t_id<80). The subcarrier spacing (SCS) for the determination of t_id is based on the value of μ. f_id is the index of the PRACH occasion in the frequency domain (0<=f_id<8). ul_carrier_id is the UL carrier used for RA preamble transmission (0 for normal uplink (NUL) carrier, 1 for supplementary uplink (SUL) carrier). The MSGB-RNTI is the RNTI for two-step RACH.

### (PDCCH Order)

### <DCI Format for PDCCH Order>

The DCI format 1_0 includes a DCI format identifier field, a bit field that is always set to 1, and a frequency domain resource assignment field. If the cyclic redundancy check (CRC) of the DCI format 1_0 is scrambled by the C-RNTI and the frequency domain resource assignment field is all 1, then the DCI format 1_0 is for a random access procedure initiated by the PDCCH order, and the remaining fields are a random access preamble, a UL/supplementary Uplink (SUL) indicator, a SS/PBCH index (SSB index), a PRACH mask index, and reserved bits (12 bits).

### <PRACH Occasion>

For a PRACH transmission triggered by the PDCCH order, the PRACH mask index field indicates the PRACH occasion of the PRACH transmission that is associated with the SS/PBCH block index indicated by the SS/PBCH block index field of the PDCCH order unless the value of the random access preamble index field is zero.

For a PRACH transmission triggered by a higher layer (PRACH transmission not triggered by the PDCCH order), if ssb-ResourceList is provided, the PRACH mask index is indicated by ra-ssb-OccasionMaskIndex. The ra-ssb-OccasionMaskIndex indicates the PRACH occasion for the PRACH transmission associated with the selected SS/PBCH block index.

The PRACH occasions are mapped consecutively for each corresponding SS/PBCH block index. The indexing of the PRACH occasions indicated by the mask index value is reset for each SS/PBCH block index and for each mapping cycle of consecutive PRACH occasions. The UE selects, for PRACH transmission, the PRACH occasion indicated by the PRACH mask index value for the specified SS/PBCH block index in the first available mapping cycle.

For the specified preamble index, the order of the PRACH occasions is as follows:
First, increasing order of frequency resource index for frequency multiplexed PRACH occasions
Second, increasing order of time resource index for time multiplexed PRACH occasions within a PRACH slot
Third, ascending order of PRACH slot index.

For PRACH transmissions triggered upon request from a higher layer, if csirs-ResourceList is provided, the value of ra-OccasionList indicates the list of PRACH occasions for the PRACH transmission, where the PRACH occasions are associated with the selected CSI-RS index indicated by csi-RS. The indexing of the PRACH occasions indicated by ra-OccasionList is reset every association pattern period.

The value of the PRACH mask index value (msgA-SSB-SharedRO-MaskIndex) is associated with the allowed PRACH occasions (PRACH occasion index values) of the SSB.

### <Random Access Procedure in MAC Entity>

The random access procedure is initiated by the PDCCH order, by the MAC entity itself, or by the RRC for specification compliant events. In the MAC entity, there can only be one random access procedure in progress at any time. The random access procedure of the SCell is only initiated by the PDCCH order with ra-PreambleIndex different from 0b000000.

When a random access procedure is initiated on the serving cell, the MAC entity performs the following:
set RA_TYPE to 4-stepRA if the random access procedure is initiated by the PDCCH order and ra-PreambleIndex explicitly provided by the PDCCH is not 0b000000, or if a random access procedure is initiated for a reconfiguration with synchronization and a contention-free random access resource of four-step RA type is explicitly provided by rach-ConfigDedicated to the BWP selected for the random access procedure.

If the selected RA_TYPE is set to 4-stepRA, the MAC entity performs the following:
If ra-PreambleIndex is explicitly provided by the PDCCH and ra-PreambleIndex is not 0b000000, set PREAMBLE INDEX to the notified ra-PreambleIndex and select the SSB notified by the PDCCH.
If the SSB is selected as above, determine the next available PRACH occasion from the PRACH occasions allowed by the restrictions given by ra-ssb-OccasionMaskIndex and corresponding to the selected SSB (the MAC entity selects a PRACH occasion randomly with equal probability from among consecutive PRACH occasions corresponding to the selected SSB according to the specifications. The MAC entity may take into account possible occurrence of a measurement gap when determining the next available PRACH occasion corresponding to the selected SSB).

### <Time Between PDCCH Order Reception and PRACH Transmission>

If the random access procedure is initiated by the PDCCH order, the UE, if requested by a higher layer, transmits PRACH within the selected PRACH occasion as described in the specification if the time between the last symbol of the PDCCH order reception and the first symbol of the PRACH transmission is greater than or equal to N_(T,2)+Δ_BWPSwitching+Δ_Delay+T_switch [msec] (time condition), where N_(T,2) is the duration of N_2 symbols corresponding to the PUSCH preparation time of UE processing capability 1. It is assumed that u corresponds to the minimum subcarrier spacing (SCS) setting between the SCS configuration of the PDCCH order and the SCS configuration of the corresponding PRACH transmission. If the active UL BWP does not change, then Δ_BWPSwitching=0, otherwise Δ_BWPSwitching is defined in the specification. In FR1 Δ_delay=0.5 msec, and in FR2, Δ_delay=0.25 msec. T_switch is the switching gap duration defined in the specification.

### <Conditions for Valid/Invalid PRACH Occasions (Validity Conditions)>

In paired spectrum (FDD) or SUL band, all PRACH occasions are valid. In unpaired spectrum (TDD), PRACH occasions may follow provisions 1 and 2 below.

### [Provision 1]

If the UE is not provided with tdd-UL-DL-ConfigurationCommon, a PRACH occasion in the PRACH slot is valid if it does not precede an SS/PBCH block in the PRACH slot and starts at least N_gap symbols after the last SS/PBCH block reception symbol. N_gap is defined in the specification. If channelAccessMode=semistatic is provided, it does not overlap with the set of consecutive symbols before the start of the next channel occupancy period during which the UE does not transmit. The candidate SS/PBCH block indices of the SS/PBCH blocks correspond to the SS/PBCH block indices provided by ssb-PositionsInBurst in SIB1 or in ServingCellConfigCommon.

### [Provision 2]

If the UE is provided with tdd-UL-DL-ConfigurationCommon, then a PRACH occasion in the PRACH slot is valid if:
the PRACH occasion is in the UL symbol, or
the PRACH occasion does not precede an SS/PBCH block in the PRACH slot and starts at least N_gap symbols after the last DL symbol and at least N_gap symbols after the last SS/PBCH block symbol. N_gap is defined in the specification. If channelAccessMode=semistatic is provided, the PRACH occasion does not overlap with the set of consecutive symbols before the start of the next channel occupancy period during which there should not be any transmission, as described in the specification. The candidate SS/PBCH block indices of the SS/PBCH block correspond to the SS/PBCH block index provided by ssb-PositionsInBurst in SIB1 or in ServingCellConfigCommon, as described in the specification.

### (Step 4 in CBRA)

Step 4 (Msg4) in the Rel-16 NR RA procedure follows the following step 4 operations:

### [Step 4 Operation]

If the UE is not provided with a C-RNTI, in response to a PUSCH transmission scheduled by the RAR UL grant, the UE schedules a PDSCH including UE contention resolution identity and attempts to detect the DCI format 1_0 with CRC scrambled by the corresponding TCI-RNTI. In response to receiving the PDSCH including the UE contention resolution identity, the UE transmits HARQ-ACK information in the PUCCH. The PUCCH transmission is in the same active UL BWP as the PUSCH transmission. The minimum time between the last symbol of the PDSCH reception and the first symbol of the corresponding PUCCH transmission including the HARQ-ACK information is equal to N_T,1 [msec]. N_T,1 is the duration of N_T,1 symbols, which corresponds to the PDSCH processing time of UE processing capability 1 when additional PDSCH DM-RS is configured. For μ=0, the UE assumes N_T,1=14.

When detecting the DCI format in response to a PUSCH transmission scheduled by the RAR UL grant or in response to a corresponding PUSCH retransmission scheduled by DCI format 0_0 with CRC scrambled by the TC-RNTI provided in the corresponding RAR message, the UE may assume that the PDCCH carrying the DCI format has the same DM-RS antenna port quasi co-location (QCL) properties as the DM-RS antenna port QCL properties for the SS/PBCH block used by the UE for PRACH association, regardless of whether the UE has been provided with a TCI state for the CORESET in which the UE received a PDCCH with the DCI format.

### (RAR Reception and QCL Assumption)

In response to a PRACH transmission, the UE attempts to detect the DCI format 1_0 with CRC scrambled by the corresponding RA-RNTI in the above-mentioned higher layer controlled window. The window starts at the first symbol of the earliest CORESET for which the UE is configured to receive a PDCCH for the Type 1-PDCCH CSS set, that is, at least one symbol after the last symbol of the PRACH occasion corresponding to the PRACH transmission. The symbol period corresponds to the SCS for the Type 1-PDCCH CSS set. The length of the window is given by ra-responseWindow in number of slots, based on the SCS for the Type 1-PDCCH CSS set.

If the UE detects the DCI format 1_0 with a CRC scrambled by the corresponding RA-RNTI and the least significant bits (LSBs) of the system frame number (SFN) field in the DCI format that are the same as the LSBs of the SEN with which the UE transmitted the PRACH, and the UE receives a transport block in the corresponding PDSCH, the UE may assume the same DMRS antenna port QCL properties for the SS/PBCH block or CSI-RS resource that the UE uses for PRACH association, regardless of whether the UE is provided with a TCI-State for the CORESET in which it receives the PDCCH with that DCI format 1_0.

If the UE attempts to detect the DCI format 1_0 with CRC scrambled by the corresponding RA-RNTI in response to the PRACH transmission initiated by the PDCCH order triggering a CFRA procedure for the SpCell, the UE may assume that the PDCCH including the DCI format 1_0 and the PDCCH order have the same DMRS antenna port QCL properties. If the UE attempts to detect the DCI format 1_0 with CRC scrambled by the corresponding RA-RNTI in response to a PRACH transmission initiated by the PDCCH order triggering a CFRA procedure for the secondary cell, the UE may assume the DMRS antenna port QCL properties of the CORESET associated to the Type 1-PDCCH CSS set for reception of the PDCCH including the DCI format 1_0.

The RAR UL grant may include at least one of a frequency hopping flag field, a PUSCH frequency resource allocation field, a PUSCH time resource allocation field, a modulation and coding scheme (MCS) field, a TPC command field for PUSCH, a CSI request field, and a channel access-cyclic prefix extension (CPext) field.

If the preamble is repeated with the plurality of different beams (on different SSBs or different ROs associated with different CSI-RSs), the UE may assume different QCLs (for example, beams) for reception of Msg2 (for example, a base station response to RAR, BFR). For a UE with limited coverage, the purpose of PRACH repetition with the plurality of different beams is to improve the decoding performance of the base station (assuming beam correspondence at the UE, same DL/UL beams at the UE). It does not mean that the UE can decode DL reception with the plurality of different beams. That is, the following observation 1 is obtained.

### [Observation 1]

For Msg2 reception after PRACH repetitions with the plurality of different beams, it is preferable for the UE to monitor Msg2 with one beam (at least in FR2).

Based on the observation 1, the base station and the UE need to have a common understanding of the QCL assumptions for Msg2 reception. It is not clear how to achieve a common understanding of the QCL assumptions for PRACH repetitions with the plurality of different beams. That is, the following observation 2 is obtained.

### [Observation 2]

If the UE assumes one QCL assumption for reception (at least in FR2), the base station and the UE should have a common understanding regarding the QCL assumption for Msg2 reception. The CFRA can make the common understanding easier.

The CBRA is mainly initiated by MAC/RRC. The CFRA can be initiated by the PDCCH order or MAC/RRC (for example, BFR, listen before transmission (LBT) failure, system information (SI) request, or the like). For different cases, the solutions to the following problems are not clear:
Whether PRACH repetitions with the plurality of different beams are applied or not.
Determining a plurality of different available beams and the number of available repetitions with the plurality of different beams.
Determining the QCL assumptions for Msg2 reception.

Assumed here are the same beam for DL and UL at the UE and one QCL assumption of the reference beam for RAR reception. However, maximum permitted exposure (MPE)/maximum power reduction (MPR), different best beams are possible for DL and UL. In addition to PRACH coverage extension, it is possible to use PRACH with the plurality of different beams to improve the UL beam. The following assumptions 1 and 2 are considered.

### [DL/UL Beam Assumption 1]

An existing PRACH is performed to identify the best DL beam. In this case, additional PRACH repetitions with the plurality of different beams (CFRA or CBRA) may be triggered for UL beam management.

### [DL/UL Beam Assumption 2]

Embodiments #1/#2 described later are used for PRACH repetitions with the plurality of different beams, where the reference resource/reference beam are specified and the QCL assumption of Msg2 is assumed to be the same as the reference beam. Therefore, the best DL beam is identified as the same as the reference beam. In this case, an extension is considered to realize further UL beam management.

### (Power Control Process for PRACH)

The transmission power of the preamble (PRACH) is calculated by the UE. The transmission power of the PRACH is determined by an open-loop power control and a power lifting/ramping mechanism. The UE calculates the transmission power based on the received power configured by the network and the value of a preamble power ramping counter.

In the existing standard, the preamble target received power is given by the following formula:

PREAMBLE_RECEIVED_TARGET_POWER=preambleReceivedTargetPower+DELTA_PREAMBLE+(PREAMBLE_POWER_RAMPING_COUNTER−1)×PREAMBLE_POWER_RAMPING_STEP

preambleReceivedTargetPower is the initial random access preamble power for the four-step RA type. DELTA_PREAMBLE relates to the preamble format. PREAMBLE_POWER_RAMPING_COUNTER is the number of times the power is increased. PREAMBLE_POWER_RAMPING_STEP is the ramping step (step size).

The UE determines (actual) transmit power P_{PRACH,b,f,c} (i) of the PRACH on the active UL BWP b of a carrier f of a serving cell c based on the DL RS for the serving cell c in a transmission occasion i as follows:

$${P}_{PRACH , b , f , c} ( i ) = min \{ {P}_{CMAX , f , c} ( i ) , {P}_{PRACH , target , f , c} + {PL}_{b , f , c} \} [ dBm ]$$

P_{CMAX,f,c}(i) is the maximum output power configured to the UE for the carrier f of the serving cell c in the transmission occasion i. P_{PRACH,target,f,c} is the PRACH target received power PREAMBLE_RECEIVED_TARGET_POWER provided by a higher layer for the active UL BWP b of the carrier f of the serving cell c. PL_{b,f,c} is the path loss for the active UL BWP b of the carrier f based on the DL RS associated with the PRACH transmission on the active DL BWP of the serving cell c, calculated by the UE as (reference signal power (referenceSignalPower, ss-PBCH-BlockPower) [dBm]−higher-layer filtered RSRP [dBm]) [dB]. If the active DL BWP is the initial DL BWP and is for multiplexing pattern 2 or 3 of the SS/PBCH block and CORESET, the UE determines PL_{b,f,c} based on the SS/PBCH block associated with the PRACH transmission.

The DL RS used in the path loss calculation may be called pathloss (PL)-RS, a pathloss reference RS, or the like.

In the existing RACH process (procedure), if the UE sends a PRACH and does not receive a network RAR or Msg4 of contention/conflict resolution within a certain time window and the random access process is not completed, the UE will retransmit the PRACH after a random backoff time.

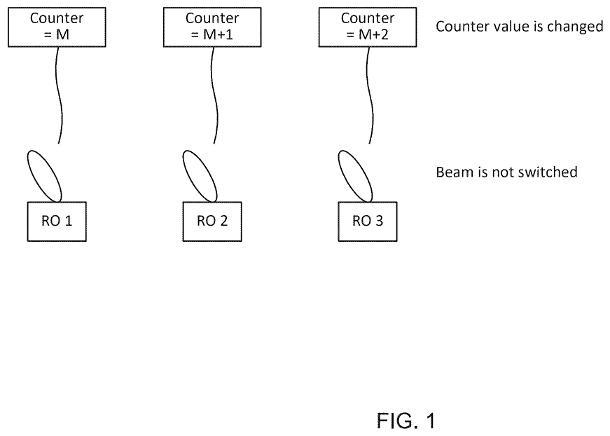

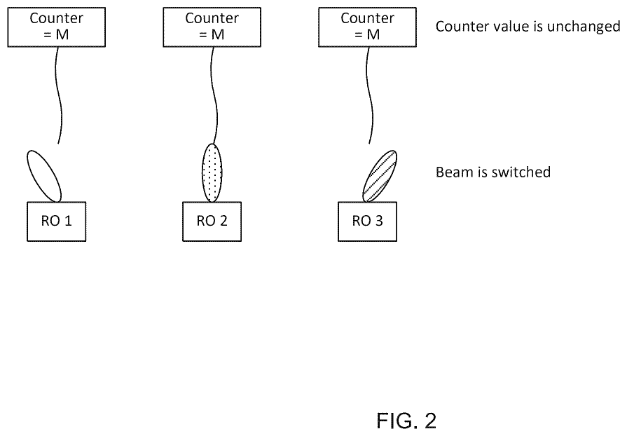

If the UE supports a plurality of transmit (TX) beams, the power lifting/ramping mechanism complies with the following:
If the transmission beam is not changed, the power of the newly transmitted PRACH is increased based on the last transmission power. If the selected SSB or CSI-RS is not changed from the selection in the last random access preamble transmission, the preamble power ramping counter is incremented by 1. In the example of FIG. 1, the ROs 1 to 3 are associated with the same beam. When a preamble is transmitted in the ROs 1 to 3, the counter value is changed.
When the UE changes the transmit beam, the preamble power ramping counter is not changed. In the example of FIG. 2, the ROs 1 to 3 are associated with different beams. When a preamble is transmitted in the ROs 1 to 3, the counter value is not changed.

In the existing process, when the random access process (procedure) completes, the preamble power ramping counter is reset. The completion flag of the random access process is either completion 1 or 2 as follows.
(Completion 1) The random access succeeds and the random access process completes. It complies with the following operations:
   When a random access preamble is transmitted, regardless of the possibility of occurrence of a measurement gap, the MAC entity starts the RAR window (ra-ResponseWindow) configured in BeamFailureRecoveryConfig or in RACH-ConfigCommon at the first PDCCH occasion from the end of transmission of the random access preamble. The MAC entity then monitors the PDCCH of the SpCell for the RAR identified by the RA-RNTI during the operation of ra-ResponseWindow.
   On the serving cell where the preamble is transmitted, if notification of the reception of a PDCCH transmission on the search space specified by recoverySearchSpaceId is received from a lower layer, and the PDCCH transmission is addressed to the C-RNTI, and a CFRA preamble for a beam failure recovery request has been transmitted by the MAC entity, then the MAC entity considers that the random access procedure has succeeded and completed.
   Otherwise, if a valid DL assignment is received on the PDCCH for the RA-RNTI and the received TB is successfully decoded, the MAC entity complies with the following (1) to (3):
(1) If the RAR includes a MAC sub-PDU with a random access preamble identifier corresponding to the transmitted PREAMBLE INDEX, the MAC entity considers that the random access procedure has succeeded and completed.
(2) If the RAR includes a MAC sub-PDU with only a RAPID (random access preamble identifier), the MAC entity considers that the random access procedure has succeeded and completed.
(3) If the random access preamble is a preamble that was not selected by the MAC entity among CBRA preambles, the MAC entity considers that the random access procedure has succeeded and completed.
   When Msg3 is transmitted, for each HARQ retransmission within the first symbol after the end of Msg3 transmission, the MAC entity starts ra-ContentionResolutionTimer and restarts ra-ContentionResolutionTimer. The MAC entity then monitors the PDCCH during the operation of ra-ContentionResolutionTimer, regardless of the possibility of occurrence of a measurement gap. If notification of receipt of the PDCCH transmission for the SpCell is subsequently received by lower layers and a C-RNTI MAC CE is included in Msg3, the MAC entity complies with the following: If an SpCell beam failure recovery random access procedure is initiated and the PDCCH transmission is addressed to the C-RNTI, or if the random access procedure is initiated by the PDCCH order and the PDCCH transmission is addressed to the C-RNTI, or if the random access procedure is initiated by the MAC sublayer itself or the RRC sublayer and the PDCCH transmission is addressed to the C-RNTI and includes an UL grant for a new transmission, the MAC entity considers that the random access procedure has succeeded and completed.
   Otherwise, if Msg3 includes a common control channel (CCCH, logical channel) service data unit (SDU), the PDCCH transmission is addressed to TEMPORARY C-RNTI, and the MAC PDU is successfully decoded, and if the MAC PDU includes a UE contention resolution identifier (UE Contention Resolution Identity) MAC CE and the UE contention resolution identifier in the MAC CE matches the CCCH SDU transmitted in Msg3, then the MAC entity considers that the random access procedure has succeeded and completed.
(Completion 2) The random access fails and the random access process completes. It complies with the following operations:
   If any of the following (1) to (3) is satisfied, the MAC entity discards TEMPORARY C-RNTI and considers that contention resolution has failed.
(1) ra-ResponseWindow configured in the beam failure recovery configuration (BeamFailureRecoveryConfig) expires, and a PDCCH transmission on the search space specified by recoverySearchSpaceId addressed to the C-RNTI is not received on the serving cell to which the preamble was transmitted.
(2) ra-ResponseWindow configured in the common RACH configuration (RACH-ConfigCommon) expires and no RAR is received including a random access preamble identifier matching the transmitted PREAMBLE INDEX.
(3) The RA contention resolution timer (ra-ContentionResolutionTimer) expires.
   If the contention resolution fails, the MAC entity increments PREAMBLE TRANSMISSION COUNTER by 1. If PREAMBLE TRANSMISSION COUNTER=preambleTransMax+1, the MAC entity complies with the following (1) and (2):
(1) If a random access preamble is transmitted on the SpCell and the random access procedure is triggered due to a system information (SI) request, the MAC entity considers that the random access procedure have failed and completed.
(2) If a random access preamble is transmitted on the SCell, the MAC entity considers that the random access procedure have failed and completed.

The transmission power increased by the power ramping of the preamble is limited by above-mentioned P_{CMAX,f,c}(i). The number of times (counter) the preamble is transmitted (power ramping) is limited by above-mentioned preambleTransMax.

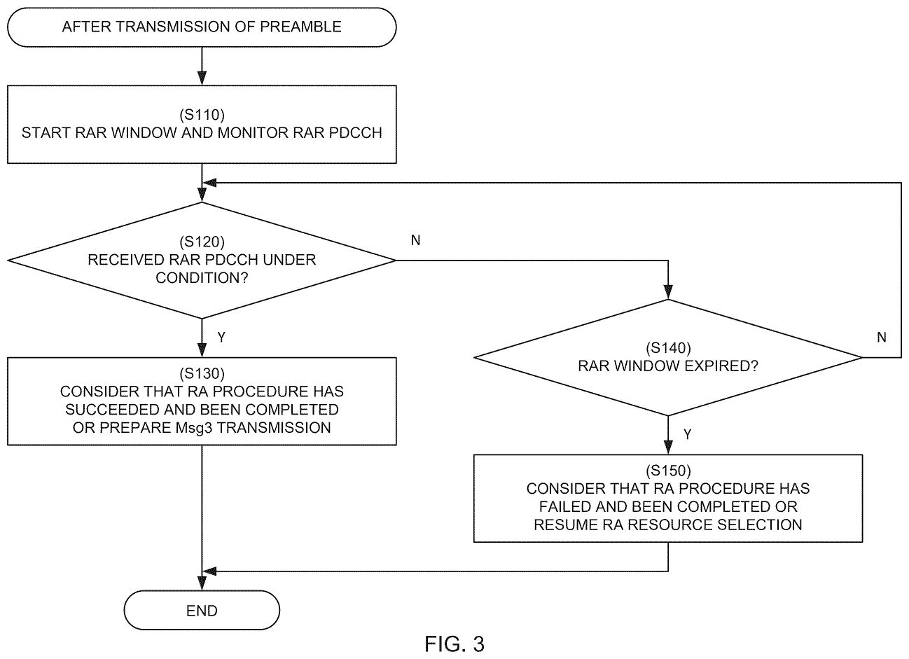

In the example of FIG. 3, after transmission of the RA preamble, the UE starts the RAR window and monitors the RAR PDCCH (S110). If the UE receives the RAR PDCCH under some conditions (S120: Y), the UE considers that the RA procedure has succeeded and completed or prepares Msg3 transmission (S130). Otherwise (S120: N), if the RAR window has expired (S140: Y), the UE considers that the RA procedure has failed and completed or restarts the RA resource selection procedure (S150). In S140, if the RAR window has not expired (S140: Y), the UE returns to S120.

### (Improvement of PRACH Uplink Coverage)

The following two types of multi-PRACH transmission are considered:

### [Type 1 Multi-PRACH Transmission]

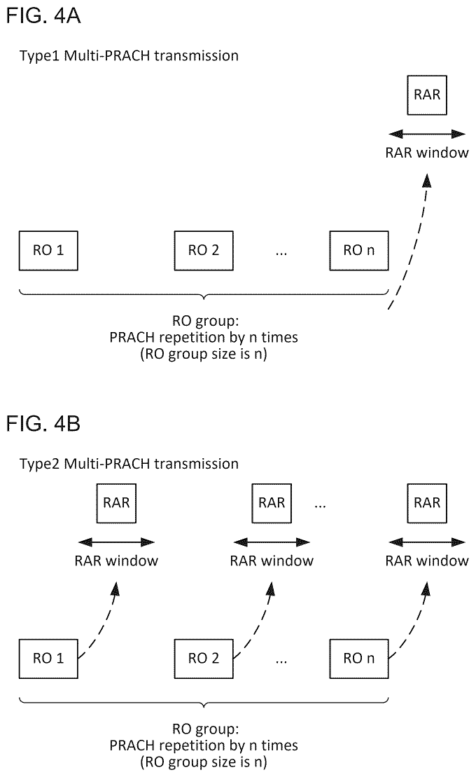

The UE repeatedly transmits Msg1 on n random access occasions (ROs)/RO resources. The UE then waits for detection of Msg2 on configured Type 1 PDCCH occasion. In the present disclosure, the repeated transmission of preambles on the n ROs/RO resources will also be referred to as an RO group. FIG. 4A shows an example of timing for Type 1 multi-PRACH transmission. In this example, the size of the RO group (the number of ROs in the RO group) is n. After one RO group, one RAR window is started.

### [Type 2 Multi-PRACH Transmission]

The UE repeatedly transmits Msg1 on the n random access occasion (RO) resources. After the transmission of Msg1 on each RO, the UE waits for the detection of Msg2 on Type 1 PDCCH occasion. FIG. 4B shows an example of timing for Type 2 multi-PRACH transmission. In this example, the size of the RO group (the number of ROs in the RO group) is n. After each RO, one RAR window is started.

Considering whether the beams of Msg1 are the same or different within one RO group, Cases 1-1 to 1-3 below are considered as use cases for Type 1 multi-PRACH transmission, and Cases 2-1 to 2-3 below are considered as use cases for Type 2 multi-PRACH transmission.

### [Case 1-1]

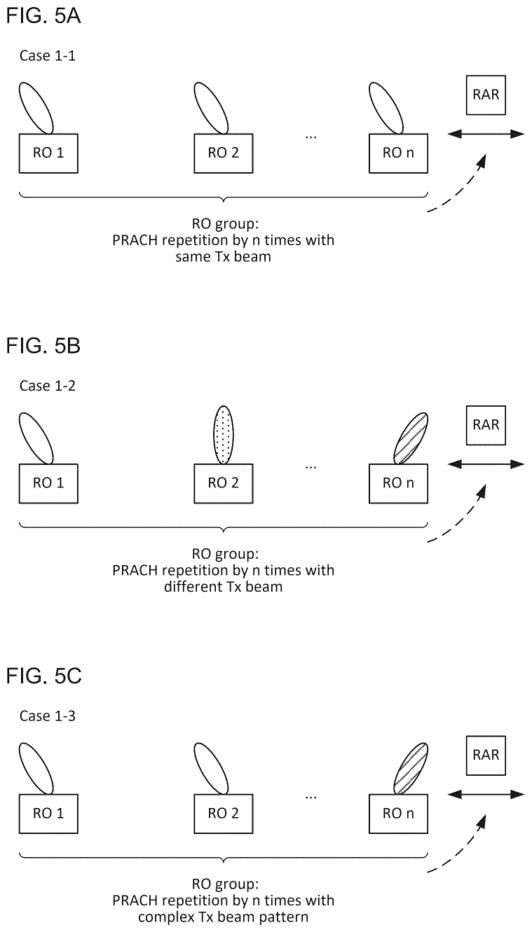

In Type 1 multi-PRACH transmission, Msg1 may be repeatedly transmitted n times using the same beam, and Msg2 may be received once. In the example of FIG. 5A, PRACH is repeatedly transmitted n times using the same transmission beam within one RO group.

### [Case 1-2]

In Type 1 multi-PRACH transmission, Msg1 may be repeatedly transmitted n times using different beams, and Msg2 may be received once. In the example of FIG. 5B, PRACH is repeatedly transmitted n times using different transmission beams within one RO group.

### [Case 1-3]

In Type 1 multi-PRACH transmission, Msg1 may be repeatedly transmitted n times using a composite beam pattern, and Msg2 may be received once. In the example of FIG. 5C, PRACH is repeatedly transmitted n times in one RO group using a composite beam pattern. In this example, the composite beam pattern may include the same beam in a plurality of ROs or may include different beams.

### [Case 2-1]

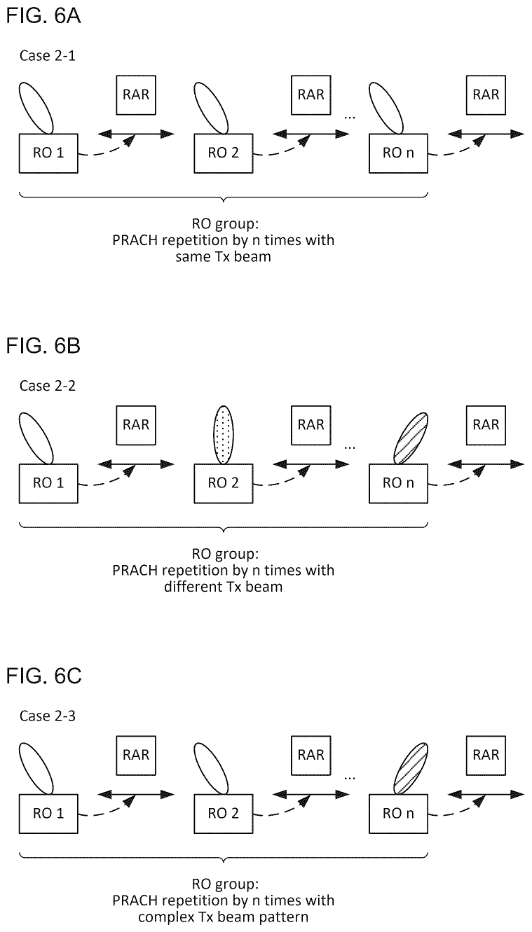

In Type 2 multi-PRACH transmission, Msg1 may be repeatedly transmitted n times using the same beam, and Msg2 may be received n times. In the example of FIG. 6A, PRACH is repeatedly transmitted n times using the same transmission beam in one RO group.

### [Case 2-2]

In Type 2 multi-PRACH transmission, Msg1 may be repeatedly transmitted n times using different beams, and Msg2 may be received n times. In the example of FIG. 6B, PRACH is repeatedly transmitted n times using different transmission beams within one RO group.

### [Case 2-3]

In Type 2 multi-PRACH transmission, Msg1 may be repeatedly transmitted n times using a composite beam pattern, and may be received n times. In the example of FIG. 6C, PRACH is repeatedly transmitted n times in one RO group using a composite beam pattern. In this example, the composite beam pattern may include the same beam in a plurality of ROs or may include different beams.

It is not clear whether a common power ramping counter or individual power ramping counters are maintained for different beams. It is not clear when the power ramping counter is changed in each case. It is not clear when the power ramping counter is reset in each case. It is not clear how to determine the power increase step size. It is not clear how to determine the PL-RS for PRACH transmission power calculation. Thus, if the determination of the PRACH transmission power is not clear, it may lead to a decrease in communication throughput, and the like.

Therefore, the inventors of the present invention have come up with the idea of a method for determining the transmission power of PRACH repetition.

Hereinafter, embodiments of the present disclosure will be described in detail with reference to the drawings. A radio communication method according to each embodiment may be applied independently or in combination.

In the present disclosure, “A/B” and “at least one of A and B” may be read interchangeably. Also, in the present disclosure, “A/B/C” may mean “at least one of A, B, and C.”

In the present disclosure, the terms such as activate, deactivate, specify (or indicate), select, configure, update, determine, and the like may be read interchangeably. In the present disclosure, the terms such as support, control, controllable, operate, and operable may be read interchangeably.

In the present disclosure, Radio Resource Control (RRC), RRC parameters, RRC messages, higher layer parameters, information elements (IEs), configurations, and the like may be read interchangeably. In the present disclosure, Medium Access Control (MAC) Control Element (CE), update commands, activation/deactivation commands, and the like may be read interchangeably.

In the present disclosure, higher layer signaling may be any of Radio Resource Control (RRC) signaling, Medium Access Control (MAC) signaling, broadcast information, and the like, or a combination of these, for example.

In the present disclosure, the MAC signaling may use a MAC Control Element (MAC CE)), MAC Protocol Data Unit (PDU), or the like, for example. The broadcast information may be a Master Information Block (MIB), a System Information Block (SIB), Remaining Minimum System Information (RMSI), Other System Information (OSI) or the like, for example.

In the present disclosure, the physical layer signaling may be Downlink Control Information (DCI), Uplink Control Information (UCI), or the like, for example.

In the present disclosure, the terms index, identifier (ID), indicator, resource ID, and the like may be read interchangeably. In the present disclosure, the terms sequence, list, set, group, cluster, subset, and the like may be read interchangeably.

In the present disclosure, the terms panel, UE panel, panel group, beam, beam group, precoder, Uplink (UL) transmission entity, Transmission/Reception Point (TRP), base station, Spatial Relation Information (SRI), spatial relation, SRS Resource Indicator (SRI), Control Resource Set (CORESET), Physical Downlink Shared Channel (PDSCH), Codeword (CW), Transport Block (TB), Reference Signal (RS), antenna port (for example, DeModulation Reference Signal (DMRS) port), antenna port group (for example, DMRS port group), group (for example, spatial relation group, Code Division Multiplexing (CDM) group, reference signal group, CORESET group, Physical Uplink Control Channel (PUCCH) group, PUCCH resource group), resource (for example, reference signal resource, SRS resource), resource set (for example, reference signal resource set), CORESET pool, downlink Transmission Configuration Indication state (TCI state) (DL TCI state), uplink TCI state (UL TCI state), unified TCI state, common TCI state, Quasi-Co-Location (QCL), QCL assumption, and the like may be read interchangeably.

In the present disclosure, SSB/CSI-RS index/indicator, beam index, and TCI state may be read interchangeably.

### (Radio Communication Method)

In each embodiment, the terms UE, MAC entity, higher layer, lower layer, and base station may be read interchangeably.

In each embodiment, the terms period, periodicity, frame, subframe, slot, symbol, occasion, and RO may be read interchangeably.

In each embodiment, the terms repetition period, repetition configuration period, repetition periodicity, and repetition cycle may be read interchangeably.

In each embodiment, the terms occasion, RACH occasion (RO), PRACH occasion, repetition resource, repetition configuration resource, resource configured for RO/repetition, time instance and frequency instance, time resource and frequency resource, RO/preamble resource, repetition may be read interchangeably.

In each embodiment, the terms PDCCH order, PDCCH order DCI, DCI format 1_0, and message (Msg) 0 may be read interchangeably. In each embodiment, the terms PRACH, preamble, PRACH preamble, sequence, preamble format, and Msg1 may be read interchangeably. In each embodiment, the terms response to PRACH, RAR, Msg2, MsgB, Msg4, base station response to BFR, and DCI for scheduling a response may be read interchangeably. In each embodiment, the terms transmission other than PRACH in a random access procedure, the Msg3, PUSCH scheduled by RAR, HARQ-ACK/PUCCH for Msg4, and MsgA PUSCH may be read interchangeably. In each embodiment, the terms Msg3, PUSCH scheduled by a RAR UL grant, and RRC connection request may be read interchangeably. In each embodiment, the terms Msg4, contention resolution, RRC connection setup, and PDSCH with UE contention resolution identity may be read interchangeably.

In each embodiment, the terms beam, SSB, and SSB index may be read interchangeably.

In each embodiment, the terms random access (RA) procedure, CFRA/CBRA, four-step RACH/two-step RACH, specific type of random access procedure, random access procedure using a specific PRACH format, random access procedure initiated by a PDCCH order, random access procedure not initiated by a PDCCH order, and random access procedure initiated by a higher layer may be read interchangeably.

In each embodiment, the terms preamble power ramping counter, counter, and counter value may be read interchangeably. In each embodiment, the terms preamble power ramping step, ramping step, and step size may be read interchangeably.

In each embodiment, the terms PL-RS, SSB, and CSI-RS may be read interchangeably.

### Embodiment #1

A common or individual ramping counters may be used for a plurality of different PRACH transmission beams.

### <<Choice 1>>

A common ramping counter may be supported for a plurality of different PRACH transmission beams. This achieves rapid increase in PRACH coverage regardless of the associated beam.

### [Method for Changing Counter Value]

The counter value may be changed according to one of the following options:

### [[Option 1]]

The change unit of the preamble power ramping counter may be RO. This may mean that each time the UE repeatedly transmits Msg1 in one RO group, the value of the power ramping counter is incremented by 1, for example, the transmission power increases according to a ramping step on each RO in one RO group.

### [[Option 2]]

The change unit of the preamble power ramping counter may be an RO group. This may mean that each time the UE repeatedly transmits Msg1 in one RO group, the value of the power ramping counter remains unchanged, for example, the same transmission power is maintained in one RO group.

### [Upper Limit of Counter Value]

To prevent the power of the preamble transmitted by the UE from being maintained at a high level, an upper limit may be introduced. If the value of the counter exceeds a pre-determined/configured upper limit, the value of the counter may be kept unchanged until the random access procedure is completed and the counter is reset.

### [Method for Resetting Counter Value]

For consistency with the existing protocol (specification), the counter may be reset when the random access procedure is completed.

### <<Choice 2>>

Individual (separate, inherent, beam-specific) ramping counters may be supported for a plurality of different PRACH transmission beams. This allows the PRACH transmission power to be appropriately adjusted depending on the associated beam. Individual ramping counters may be supported for groups of beams among the plurality of different PRACH transmission beams.

### [Method for Changing Counter Value]

For each beam-specific power ramping counter, the timing for changing the counter value may comply with the Rel-15 rules mentioned above. That is, if the UE retransmits Msg1 using a beam (direction) or if the UE repeatedly transmits Msg1 using a beam (direction), the power ramping counter corresponding to the beam may be incremented by 1.

### [Upper Limit of Counter]

To prevent the power of the preamble transmitted by the UE from being maintained at a high level, an upper limit may be introduced. The upper limit may be preambleTransMax. The upper limit may be prescribed in the specification or may be set by RRC. Regarding the upper limit, the UE may follow one of the following options:

[[Option a]]

If the counter value for a beam exceeds preambleTransMax, the counter value for the beam is maintained at preambleTransMax.

[[Option b]]

If the counter value for a beam exceeds preambleTransMax, the counter value for the beam is reset.

[[Option c]]

If the counter value for a beam exceeds preambleTransMax (and any of the conditions in “If the contention resolution fails” of “Completion 2” described above occurs), the RA procedure is considered to have failed and completed.

[[Option d]]

If all counter values (for all beams) exceed preambleTransMax (and any of the conditions in “If the contention resolution fails” of “Completion 2” described above occurs), the RA procedure is considered to have failed and completed.

### [Method for Resetting Counter Value]

For consistency with the existing protocol (specification), the counter for each beam may be reset when the random access procedure is completed.

According to the present embodiment, the UE can appropriately determine the values of one or more power ramping counters for the PRACH repetitions, and can appropriately determine the PRACH transmission power.

### Embodiment #2

The ramping step (step size) for the power ramping counter may be determined.

### <<Option 1>>

Existing rules may be reused. That is, PREAMBLE_POWER_RAMPING_STEP may be set to powerRampingStep [dB] configured by RRC IE) taken into account for all PRACH transmissions.

### <<Option 2>>

A new parameter (for example, multi-PRACHpowerRampingStep

[dB]) for multi-PRACH transmission in Rel. 18 and later may be added. For example, PREAMBLE_POWER_RAMPING_STEP may be set to the power ramping factor for multi-PRACH transmission (ramping step, multi-PRACHpowerRampingStep [dB] configured by RRC IE).

### [Option 2-1]

New parameters may be used in place of existing parameters (for example, power ramping factors) for a plurality of PRACH transmissions.

### [Option 2-2]

New parameters may be used along with existing parameters (for example, power ramping factors) for a plurality of PRACH transmissions.

The number of parameters (existing/new parameters) for the ramping steps may be the same as the number of power ramping counters. The number of parameters (existing/new parameters) for the ramping steps may be the same as the maximum number of beams used for PRACH transmission.

According to the present embodiment, the UE can appropriately determine the ramping step for the PRACH repetition and can appropriately determine the PRACH transmission power.

### Embodiment #3

The actual transmission power of the PRACH may be determined taking into account a plurality of beams.

### <<Choice 1>>

For a specific PRACH beam or a specific RO, an explicit SSB index may be configured by the RRC IE (for example, Options 1-1/1-2 described below). The actual transmission power of the PRACH may be determined based on the SSB index.

### <<Choice 2>>

The actual transmission power of the PRACH may be determined based on a default SSB. For example, the default SSB may be an SSB associated with the RO resource, an SSB with the smallest/largest SSB index among a plurality of SSBs associated with a plurality of RO resources in one RO group, an SSB with the largest/smallest RSRP/RSRQ among a plurality of SSBs associated with a plurality of RO resources in one RO group, an SSB with the smallest/largest SSB index among all received SSBs, or an SSB with the largest/smallest RSRP/RSRQ among all received SSBs (for example, Options 1-3/1-4 described below).

The UE may determine a path loss PL_{b,f,c} based on a PL-RS. The PL-RS may be an SSB or a CSI-RS.

### <<Option 1>>

The same PL-RS may be applied to a plurality of PRACH transmissions in the same RO group.

### [Option 1-1]

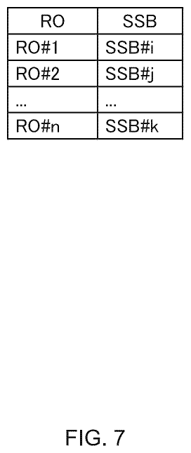

The PL-RS may be an explicit SSB index configured/specified for each PRACH beam or each RO via PBCH or Type-0 PDCCH or PDCCH order (PDCCH that triggers RA). As in the example of FIG. 7, the SSB index (association/mapping of RO and SSB index) for each RO may be configured/specified. The PL-RS may be the SSB configured/specified for the first/second/last/randomly selected RO/beam in the RO group.

### [Option 1-2]

The PL-RS may be an SSB or CSI-RS with an explicit SSB index or CSI-RS index specified by a PDCCH order (PDCCH that triggers the RA).

### [Option 1-3]

If a plurality of ROs in the RO group is associated with a plurality of different SSBs, the PL-RS may be the SSB with the smallest/largest SSB index among the plurality of SSBs associated with the plurality of RO resources in the RO group, or the SSB with the largest/smallest RSRP/RSRQ among the plurality of SSBs associated with the plurality of RO resources in the RO group. Otherwise (if the plurality of ROs in the RO group is associated with one SSB), only the SSB associated with the plurality of RO may be selected as the PL-RS.

### [Option 1-4]

The PL-RS may be the SSB with the smallest/largest SSB index among all received SSBs, or may be the SSB with the largest/smallest RSRP/RSRQ among all received SSBs, or may be the SSB with the largest/smallest RSRP/RSRQ among received SSBs with RSRPs higher than a threshold.

In the present disclosure, the phrase “via the PBCH” may be read as “via at least one of the PBCH DMRS and the (physical layer) payload of the PBCH.”

### <<Option 2>>

For each PRACH transmission in the same RO group, the PL-RS may be determined individually.

### [Option 2-1]

The PL-RS for each RO may be determined according to Rel-15 rules.

### [Option 2-2]

The PL-RS may be an explicit SSB index configured/specified for each PRACH beam or each RO via the PBCH or Type-0 PDCCH or PDCCH order (PDCCH that triggers RA). The UE may determine the PL-RS for each RO based on the mapping relation.

### [Option 2-3]

The PL-RS may be specified individually for each RO by the PDCCH order (PDCCH that triggers RA).

### [Option 2-4]

The PL-RS may be SSB/CSI-RS selected for each PRACH transmission from among the SSB/CSI-RS whose RSRP of the received SSB/CSI-RS is higher than a threshold. The selection order may follow any of the following orders:
Descending order of RSRP
Ascending order of RSRP
An order selected at random (without explicit rules, as in Rel. 17).

According to the present embodiment, the UE can appropriately determine the PL-RS for the PRACH repetition and can appropriately determine the PRACH transmission power.

### Specific Examples of Embodiment #1/Choice 1

Hereinafter, specific examples are given for each of the above cases where a common ramping counter is used for a plurality of different PRACH transmission beams.

### <<Case 1-1>>

### [Method for Changing Counter Value]

If the change unit of the preamble power ramping counter is RO (Option 1 of Method for Changing Counter Value), the UE may increment PREAMBLE_POWER_RAMPING_COUNTER by 1 each time (repetition/RO) that Msg1 in one RO group is repeatedly transmitted. This may have a strong influence on Msg1 transmitted by other UEs.

In the following example, each RO group contains n ROs (RO 1 to RO n).

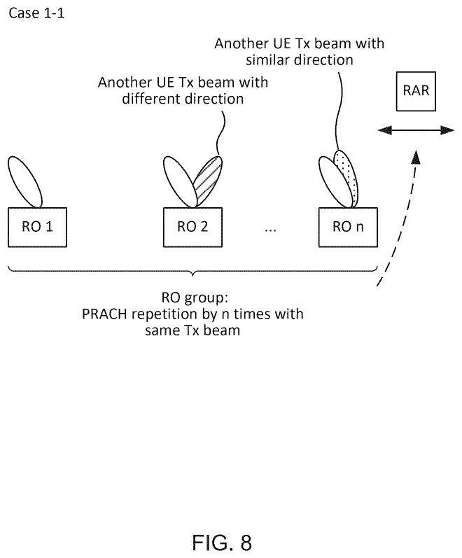

In the example of FIG. 8, Msg1 transmitted from UE 1 on RO 2 does not have a strong influence on Msg1 transmitted by another UE on the RO 2 because the beam directions are different. However, Msg1 transmitted by the UE 1 on the RO n strongly interferes with Msg1 transmitted by another UE on the RO n because the beam directions are close. At this time, the Msg1 transmission power of the UE 1 reaches a high level after several increases.

Therefore, Option 2 of Method for Changing Counter Value is preferred.

In one RO group, the UE may repeatedly transmit Msg1 using the same beam without increasing the transmission power.

The change in the value of the preamble power ramping counter among a plurality of RO groups depends on whether the beam is switched or not.

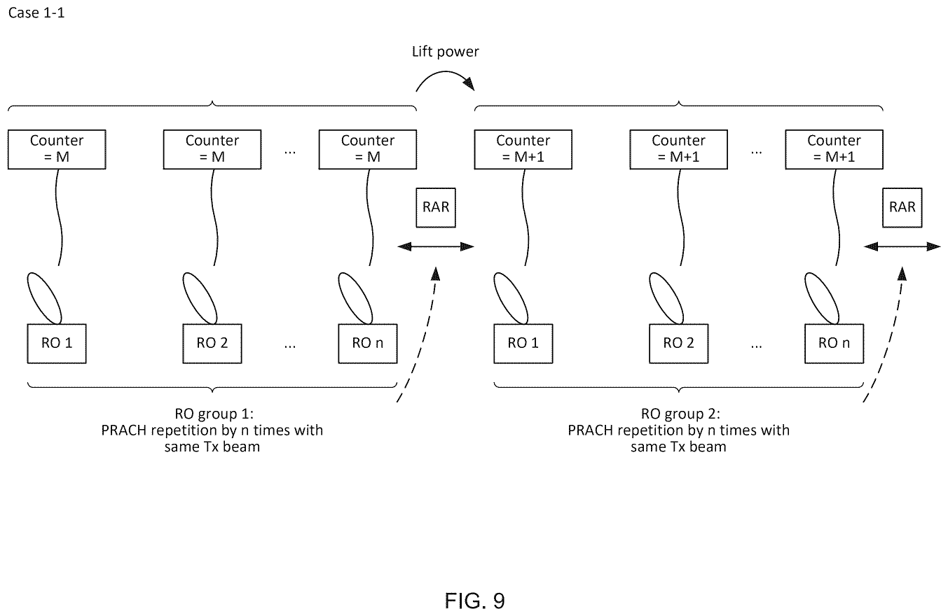

In the example of FIG. 9, if the beam is not switched among a plurality of RO groups, the power is increased by a ramping step based on the power of the previous RO group. In this example, in RO group 2, the same beam as in RO group 1 is used. In the RO group 1, the value of the preamble power ramping counter is M, and in the RO group 2, the value of the preamble power ramping counter is M+1.

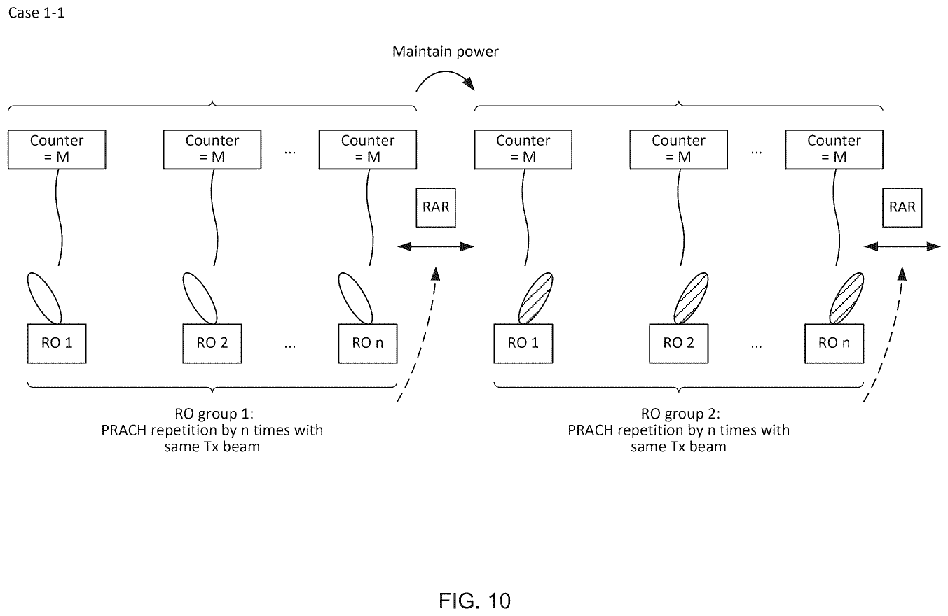

In the example of FIG. 10, if the beam is switched among a plurality of RO groups, the power of the previous RO group is maintained for transmission. In this example, a beam different from that in the RO group 1 is used in the RO group 2. In the RO group 1, the value of the preamble power ramping counter is M, and in the RO group 2, the value of the preamble power ramping counter is maintained.

### <<Case 1-2>>

### [Method for Changing Counter Value]

If the change unit of the preamble power ramping counter is RO (Option 1 of Method for Changing Counter Value), the UE may increment PREAMBLE_POWER_RAMPING_COUNTER by 1 each time (repetition/RO) that Msg1 in one RO group is repeatedly transmitted. It makes it difficult for the base station to determine whether a better UE transmission beam results from the increased power or the beam direction is more consistent. It may be detrimental to the selection of a beam pair between the UE and the base station.

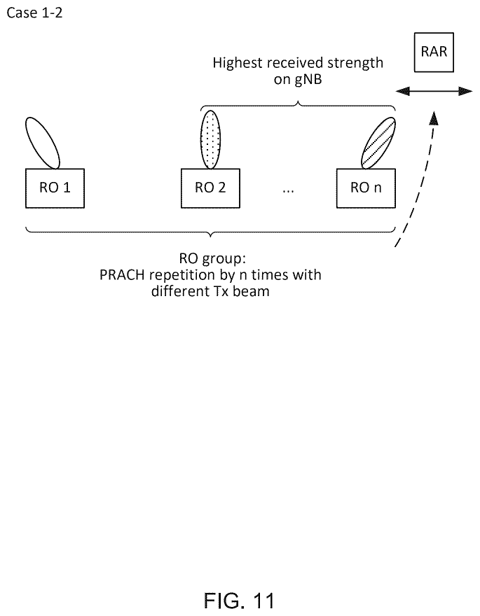

In the example of FIG. 11, the Tx beam direction of Msg1 transmitted from the UE 1 on the RO 2 matches best with the reception (Rx) beam of the base station. The beam direction of Msg1 transmitted from the UE 1 on the RO n does not match with the Rx beam of the base station, but the receiving strength on the base station side is high because the transmission power reaches a high level after several increases. The base station cannot distinguish the best Tx beam for the UE 1.

Therefore, Option 2 of Method for Changing Counter Value is preferred.

In one RO group, the UE may repeatedly transmit Msg1 using the same beam without increasing the transmission power.

Among a plurality of RO groups, the value of the preamble power ramping counter may or may not be changed.

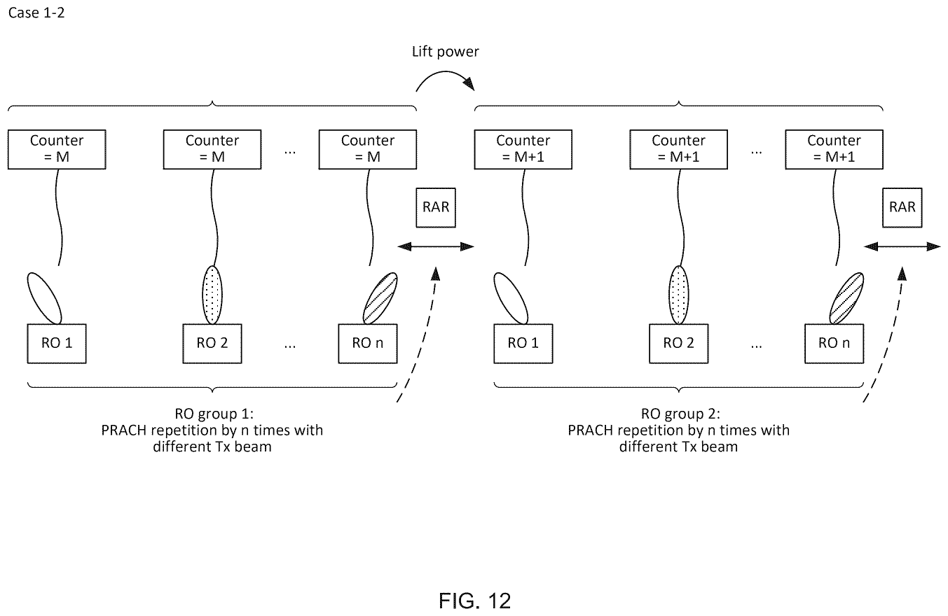

In the example of FIG. 12, the power may be increased by the ramping step based on the power of the previous RO group. In this example, in the RO group 1, the value of the preamble power ramping counter is M, and in the RO group 2, the value of the preamble power ramping counter is M+1.

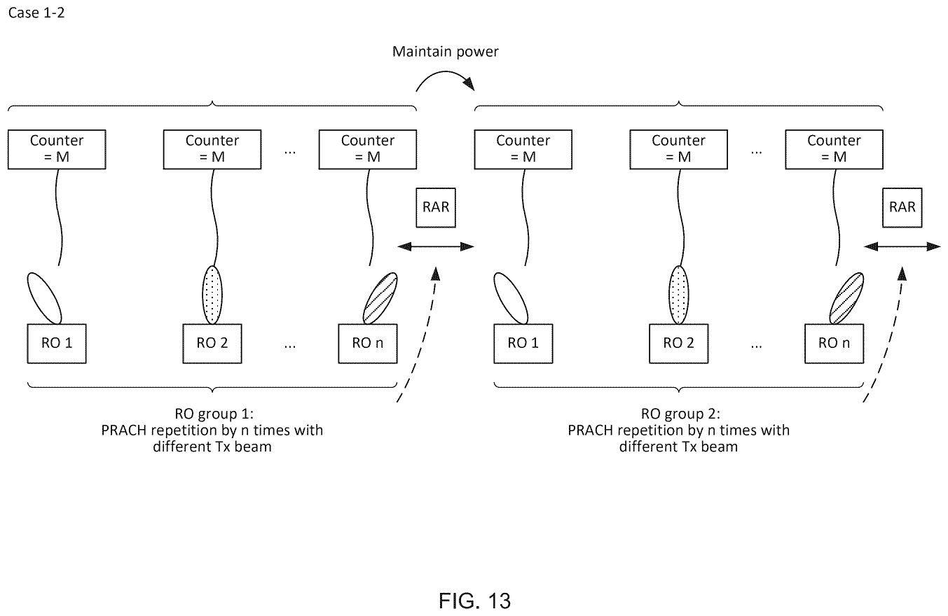

In the example of FIG. 13, if the beam is switched among a plurality of RO groups, the power of the previous RO group may be maintained for transmission. In this example, in the RO group 1, the value of the preamble power ramping counter is M, and in the RO group 2, the value of the preamble power ramping counter is maintained.

### <<Case 1-3>>

### [Method for Changing Counter Value]

If the change unit of the preamble power ramping counter is RO (Option 1 of Method for Changing Counter Value), the UE may increment PREAMBLE_POWER_RAMPING_COUNTER by 1 each time (repetition/RO) that Msg1 in one RO group is repeatedly transmitted. This may bring strong interference to Msg1 transmitted by other existing UEs that do not use multi-PRACH. It makes difficult for the base station to determine whether a better UE transmission beam results from the increased power or the beam direction is more consistent. It may be detrimental to the selection of a beam pair between the UE and the base station.

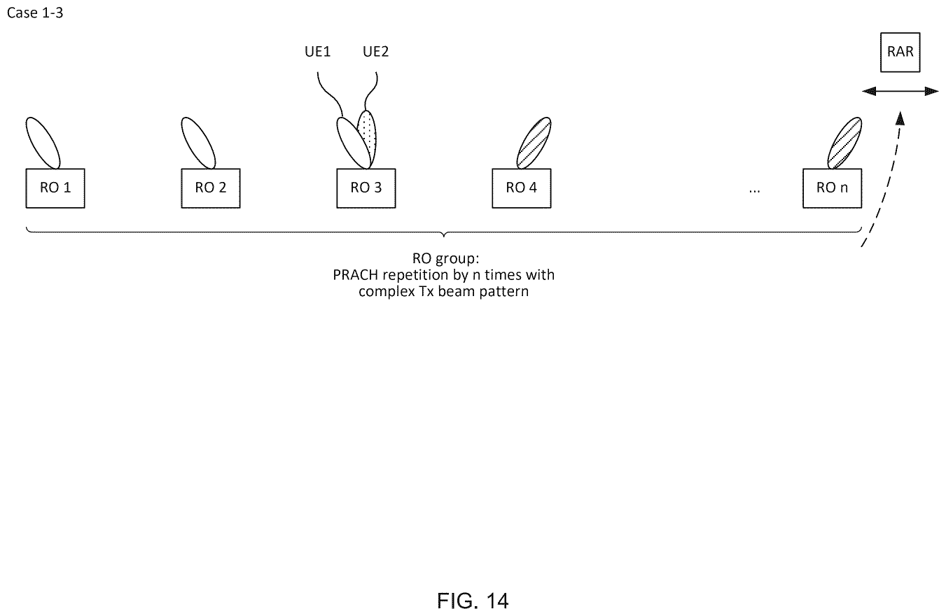

In the example of FIG. 14, the UE 1 transmits n pieces of Msg1 using a composite beam pattern in one RO group. First, Msg1 with a beam1 is transmitted three times, then Msg1 with a beam 2 is transmitted twice, and these transmissions are repeated until Msg1 is transmitted n times. If the UE 1 increases the transmission power according to the ramping step each time (repetition/RO), when the transmission of Msg1 is repeated, the transmission power of the UE 1 on the RO 3 becomes a high level, which will have a strong influence on the Msg1 transmitted by another existing UE 2 in the beam direction. Furthermore, the transmission power among a plurality of different beams should be consistent so that the base station can distinguish which Tx beam is better for the UE transmitting Msg1.

Therefore, Option 2 of Method for Changing Counter Value is preferred.

In one RO group, the UE may repeatedly transmit Msg1 using the same beam without increasing the transmission power.

Among a plurality of RO groups, the value of the preamble power ramping counter may or may not be changed.

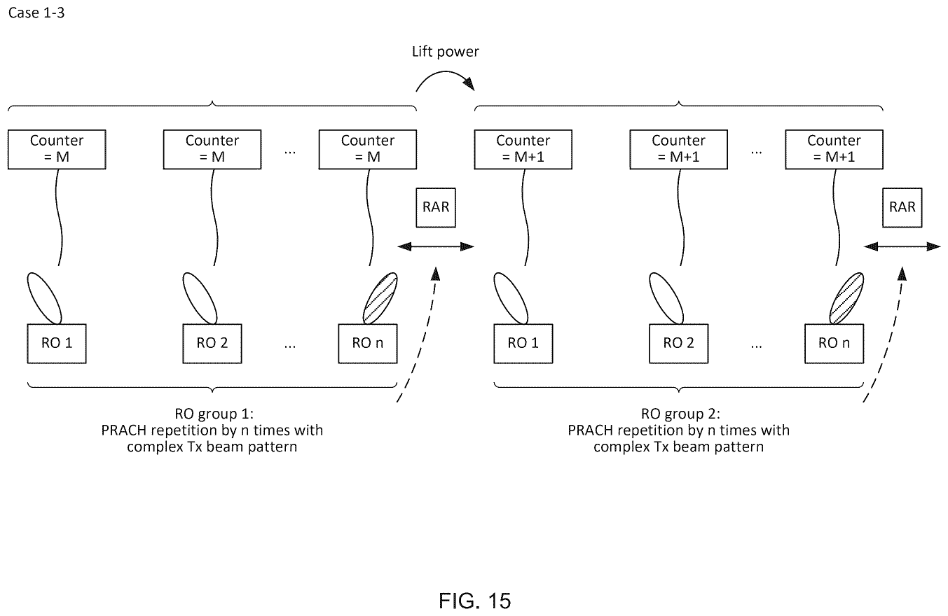

In the example of FIG. 15, the power may be increased by the ramping step based on the power of the previous RO group. In this example, in the RO group 1, the value of the preamble power ramping counter is M, and in the RO group 2, the value of the preamble power ramping counter is M+1.

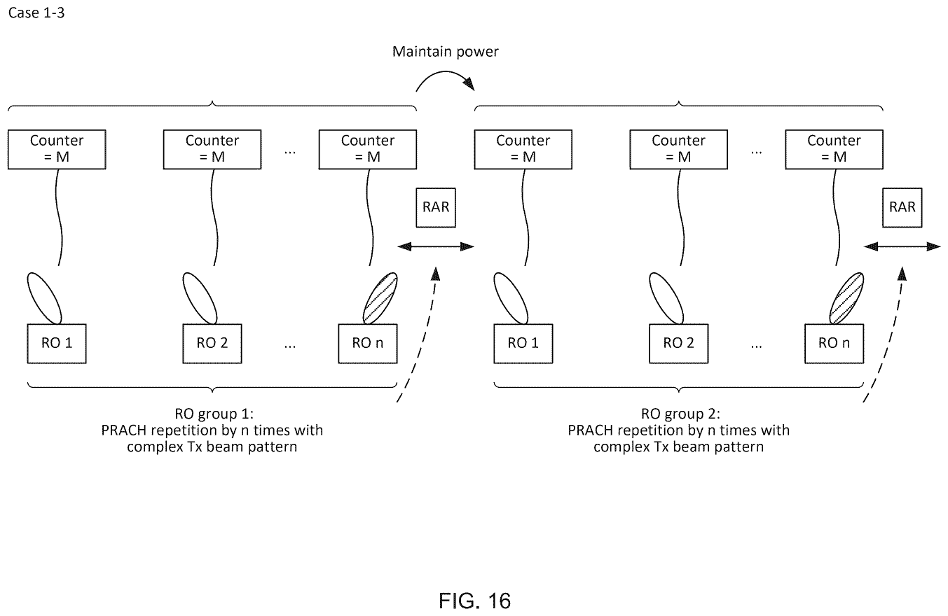

In the example of FIG. 16, if the beam is switched among a plurality of RO groups, the power of the previous RO group may be maintained for transmission. In this example, in the RO group 1, the value of the preamble power ramping counter is M, and in the RO group 2, the value of the preamble power ramping counter is maintained.

### <<Case 2-1>>

### [Method for Changing Counter Value]

The change unit of the preamble power ramping counter may be selected according to Option 1 of Method for Changing Counter Value in order to maximize the probability that UE 1 has at least one PRACH successfully received by the base station in one RO group. That is, the UE may increment PREAMBLE_POWER_RAMPING_COUNTER by 1 at each time (repetition/RO) Msg1 transmission is repeated.

### [Method for Resetting Counter Value]

To avoid the transmission power of UE 1 being maintained at a high level, the reset condition of the preamble power ramping counter may be Embodiment #1/Choice 1. That is, after reaching the upper limit value, the counter value may be kept unchanged.

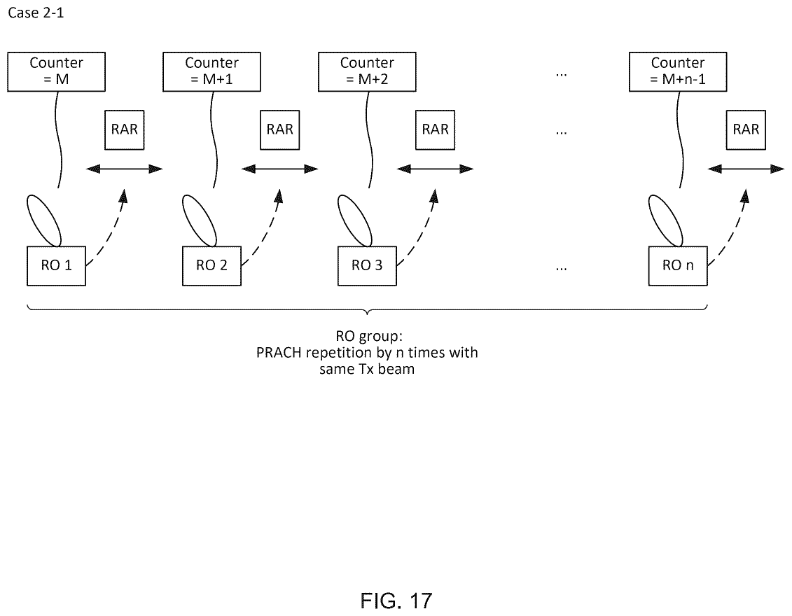

Therefore, Option 1 of Method for Changing Counter Value is preferred, and the upper limit is useful. In the example of FIG. 17, in one RO group, the UE may increment the counter value by 1 each time (repetition/RO) the Msg1 transmission is repeated.

Depending on whether the beam is switched among a plurality of RO groups, a method for changing the value of the preamble power ramping counter may be selected.

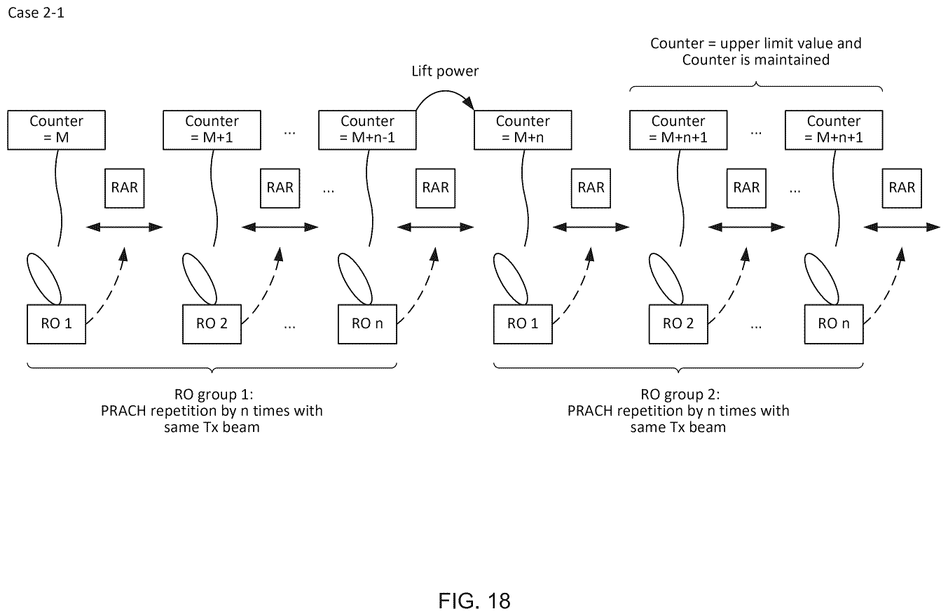

In the example of FIG. 18, if no beam is switched among a plurality of RO groups, the power may be increased by the ramping step based on the power of the previous RO group. When reaching the upper limit, the counter value is kept unchanged. In this example, between the RO n in the RO group 1 and the RO 1 in the RO group 2, the power is increased (counter value M+n−1 is incremented by 1), and at the RO 2 in the RO group 2, the counter reaches the upper limit M+n+1.

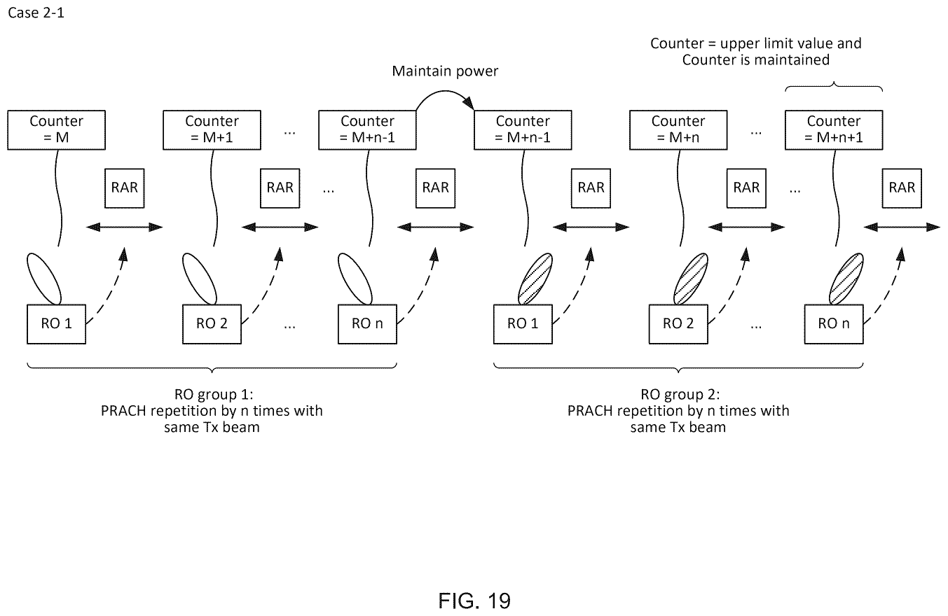

In the example of FIG. 19, if the beam is switched among a plurality of RO groups, the power of the previous RO group may be maintained for transmission. When reaching the upper limit, the counter value is kept unchanged. In this example, between the RO n in the RO group 1 and the RO 1 in the RO group 2, the power is not increased (the counter value M+n−1 is unchanged), and at the RO n in the RO group 2, the counter reaches the upper limit M+n+1.

### <<Case 2-2>>

### [Method for Changing Counter Value]

Same as Case 2-1.

### [Method for Resetting Counter Value]

Same as Case 2-1.

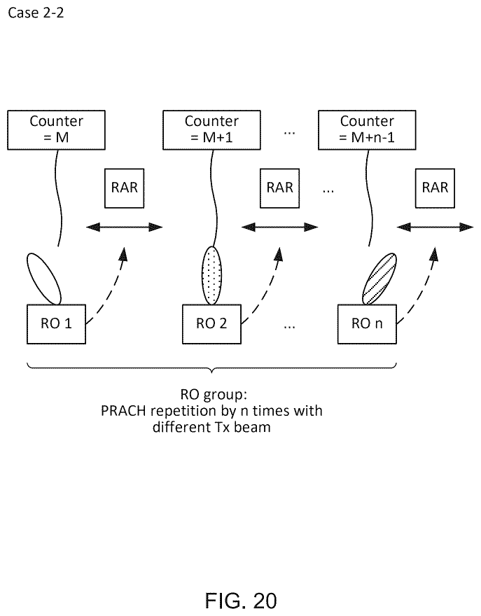

Therefore, Option 1 of Method for Changing Counter Value is preferred, and the upper limit is useful. In the example of FIG. 20, in one RO group, the UE may increment the counter value by 1 each time (repetition/RO) the Msg1 transmission is repeated.

Among a plurality of RO groups, the value of the preamble power ramping counter may or may not be changed.

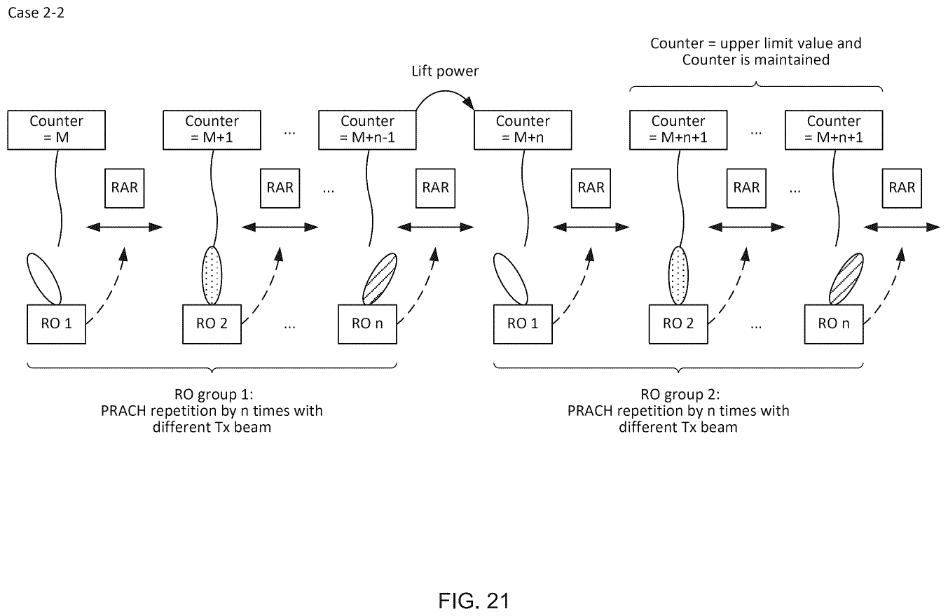

In the example of FIG. 21, the power may be increased by the ramping step based on the power of the previous RO group. When reaching the upper limit, the counter value is kept unchanged. In this example, between the RO n in the RO group 1 and the RO 1 in the RO group 2, the power is increased (the counter value M+n−1 is incremented by 1), and at the RO 2 in the RO group 2, the counter reaches the upper limit M+n+1.

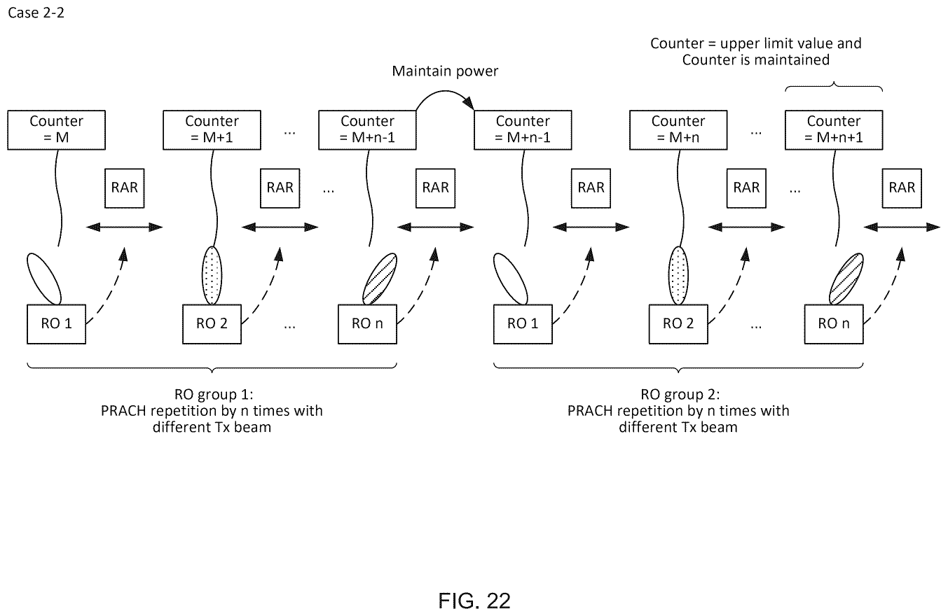

In the example of FIG. 22, the power of the previous RO group may be maintained for transmission. When reaching the upper limit, the counter value is kept unchanged. In this example, between the RO n in the RO group 1 and the RO 1 in the RO group 2, the power is not increased (the counter value M+n−1 is unchanged), and at the RO n in the RO group 2, the counter reaches the upper limit M+n+1.

### <<Case 2-3>>

### [Method for Changing Counter Value]

Same as Case 2-1.

[Method for resetting Counter Value]

Same as Case 2-1.

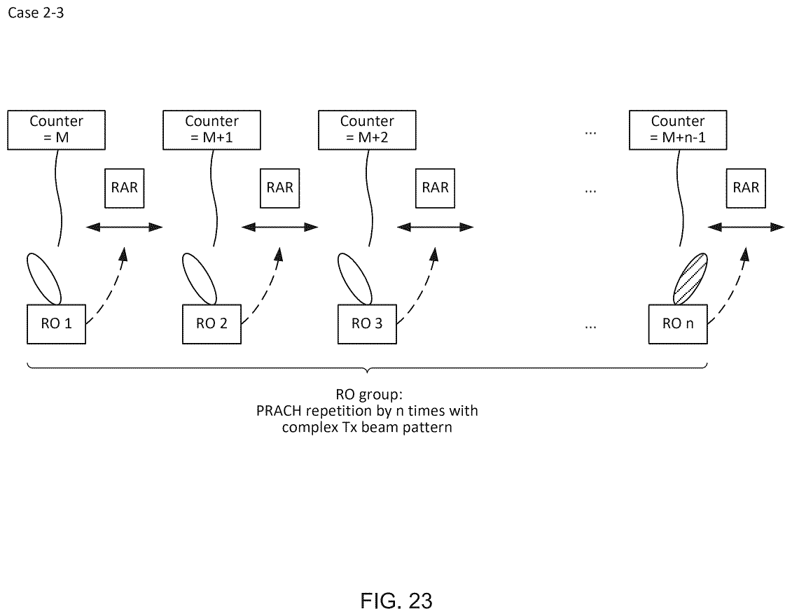

Therefore, Option 1 of Method for Changing Counter Value is preferred, and the upper limit is useful. In the example of FIG. 23, in one RO group, the UE may increment the counter value by 1 each time (repetition/RO) the Msg1 transmission is repeated.

Among a plurality of RO groups, the value of the preamble power ramping counter may or may not be changed.

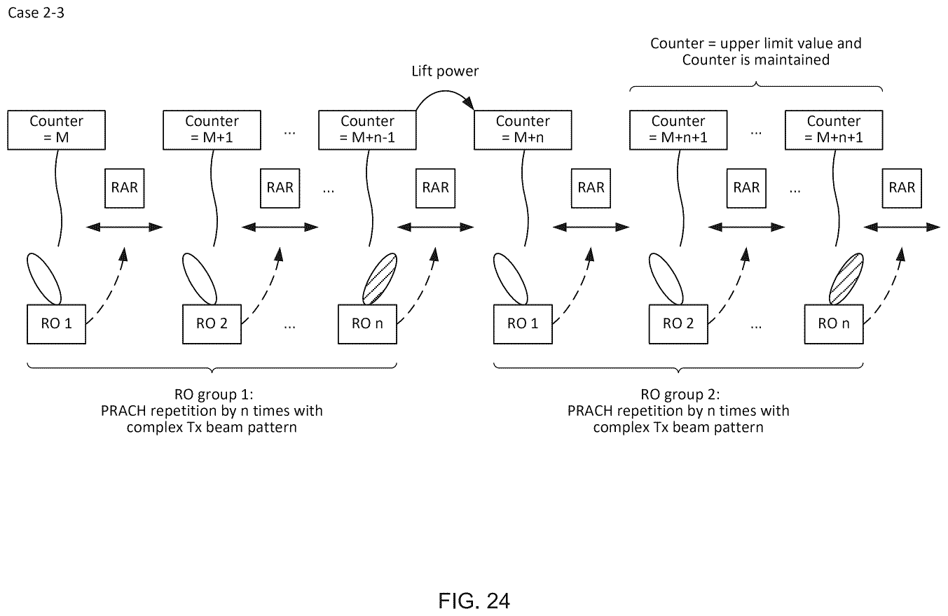

In the example of FIG. 24, the power may be increased by the ramping step based on the power of the previous RO group. When reaching the upper limit, the counter value is kept unchanged. In this example, between the RO n in the RO group 1 and the RO 1 in the RO group 2, the power is increased (the counter value M+n−1 is incremented by 1), and at the RO 2 in the RO group 2, the counter reaches the upper limit M+n+1.

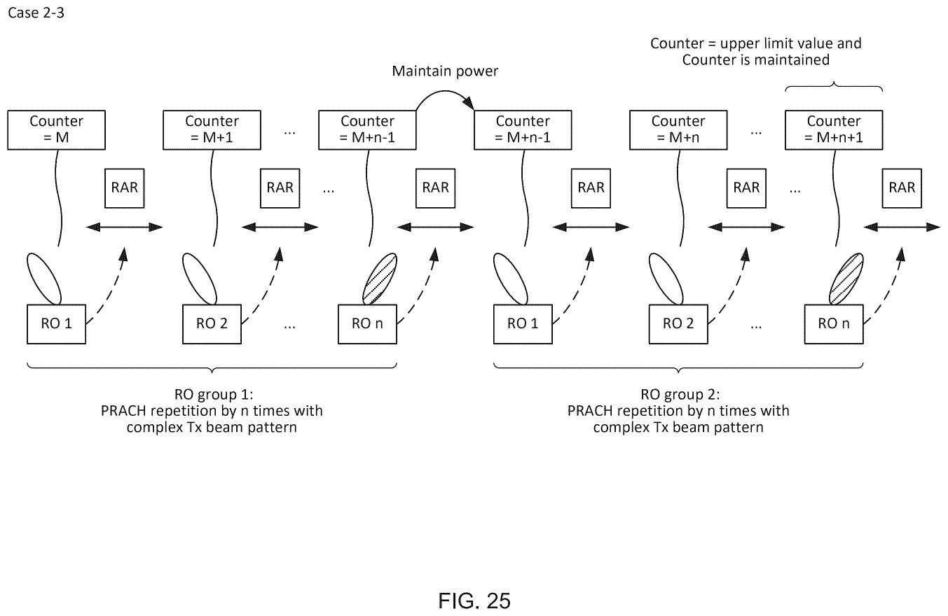

In the example of FIG. 25, the power of the previous RO group may be maintained for transmission. When reaching the upper limit, the counter value is kept unchanged. In this example, between the RO n in the RO group 1 and the RO 1 in the RO group 2, the power is not increased (the counter value M+n−1 is unchanged), and at the RO n in the RO group 2, the counter reaches the upper limit M+n+1.

### Specific Examples of Embodiment #1/Choice 2

Hereinafter, specific examples are given for each of the above cases where individual ramping counters are used for a plurality of different PRACH transmission beams.

### <<Case 1-1>>

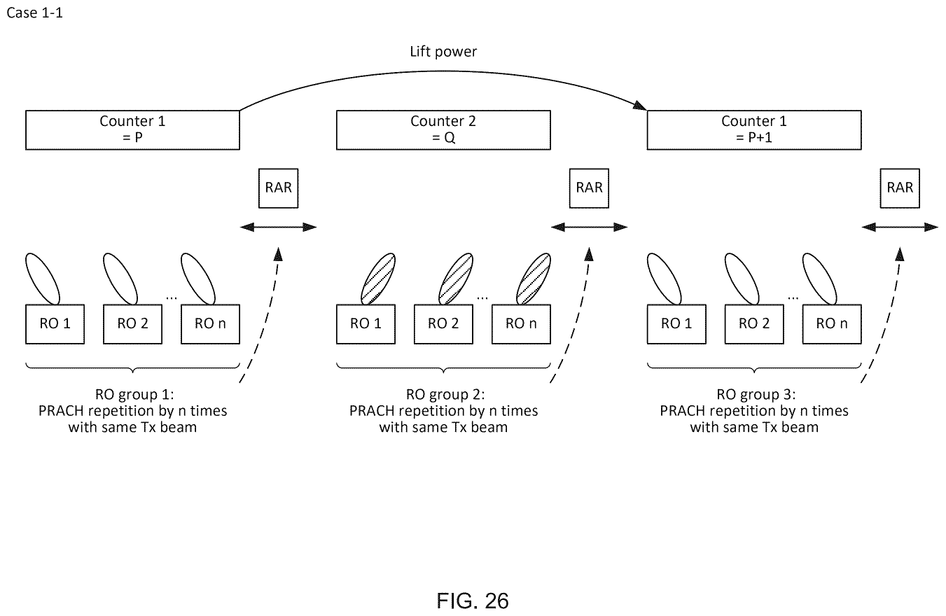

In the example of FIG. 26, the UE repeatedly transmits Msg1 using the same beam in one RO group and the power is maintained at each transmission. The UE uses beam-specific counters 1 and 2. Since the beams of the RO group 1 and RO group 3 are the same (the RO group 1 and the RO group 3 use the same counter), the transmission power of the RO group 3 is increased by the ramping step based on the transmission power of the RO group 1 instead of that of the RO group 2 (determined by incrementing the same counter as that of the RO group 1 by 1).

### <<Case 1-2>>

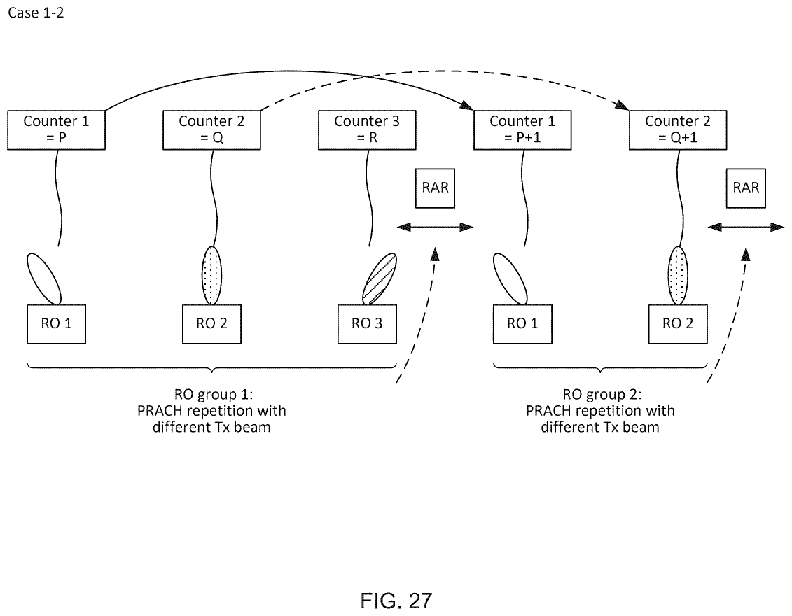

In the example of FIG. 27, the UE repeatedly transmits Msg1 using different beams in one RO group. The UE uses an independent power ramping counter in each beam direction. The transmission power of Msg1 on each beam is set according to the values of their own independent counters (beam-specific counters 1 to 3). Since the beam of the RO 1 in the RO group 2 is the same as that of the RO 1 in the RO group 1 (the RO 1 in the RO group 2 uses the same counter as that of the RO 1 in the RO group 1), the transmission power of the RO 1 in the RO group 2 is increased by the ramping step based on the transmission power of the RO 1 in the RO group 1 (determined by incrementing the same counter as that of the RO 1 in the RO group 1 by 1). Since the beam of the RO 2 in the RO group 2 is the same as the beam of the RO 2 in the RO group 1 (the RO 2 in the RO group 2 uses the same counter as that of the RO 2 in the RO group 1), the transmission power of the RO 2 in the RO group 2 is increased by the ramping step based on the transmission power of the RO 2 in the RO group 1 (determined by incrementing the same counter as that of the RO 2 in the RO group 1 by 1).

### <<Case 1-3>>

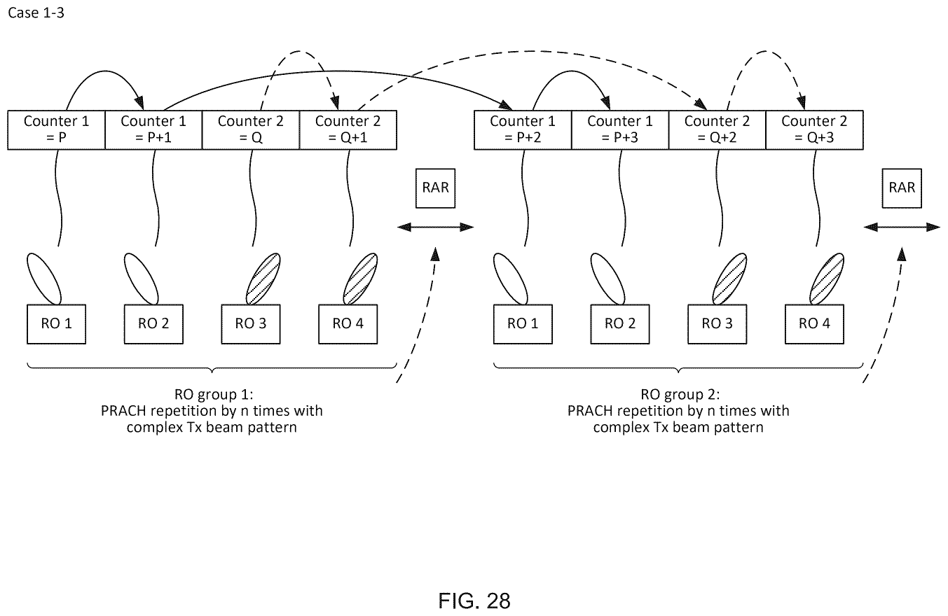

In the example of FIG. 28, the UE repeatedly transmits Msg1 using a composite beam pattern in one RO group. The UE uses independent power ramping counters in the beam directions (beam-specific counters 1 and 2). The transmission power of Msg1 on each beam is set according to the value of its own independent counter. Since the beam of the RO 1 in the RO group 2 is the same as that of the RO 2 in the RO group 1 (the RO 1 in the RO group 2 uses the same counter as that of the RO 2 in the RO group 1), the transmission power of the RO 1 in the RO group 2 is increased by the ramping step based on the transmission power of the RO 2 in the RO group 1 (determined by incrementing the same counter as that of the RO 1 in the RO group 1 by 1). Since the beam of the RO 2 in the RO group 2 is the same as the beam of the RO 2 in the RO group 1 (the RO 2 in the RO group 2 uses the same counter as that of the RO 2 in the RO group 1), the transmission power of the RO 2 in the RO group 2 is increased by the ramping step based on the transmission power of the RO 2 in the RO group 1 (determined by incrementing the same counter as that of the RO 2 in the RO group 1 by 1).

### <<Case 2-1>>

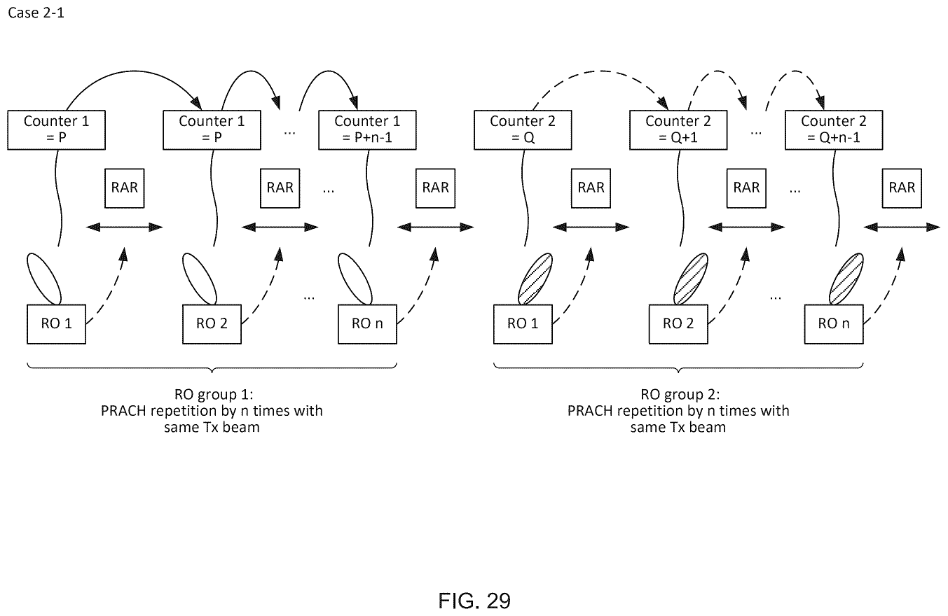

In the example of FIG. 29, the UE repeatedly transmits Msg1 using the same beam in one RO group, and the power increases by the ramping step at each transmission. The UE switches the transmission beam between two adjacent RO groups. For the beam directions, independent power ramping counters (beam-specific counters 1 and 2) are used, and the power control is performed in each beam direction according to their own counters.

### <<Case 2-2>>

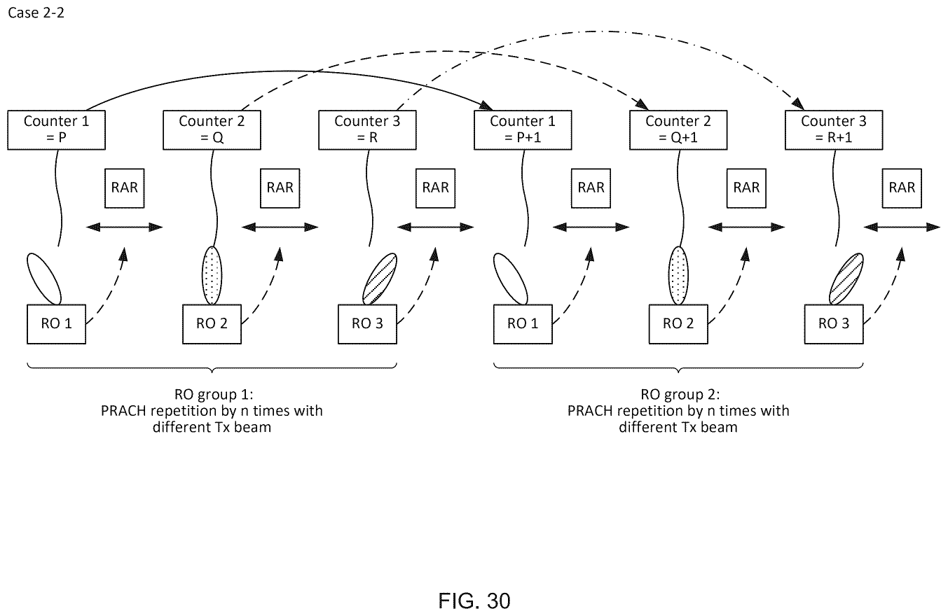

In the example of FIG. 30, the UE repeatedly transmits Msg1 using different beams in one RO group, and the transmission power is increased by the ramping step at each transmission. For the beam directions, independent power ramping counters (beam-specific counters 1 to 3) are used, and power control is performed in each beam direction according to their own counters.

### <<Case 2-3>>

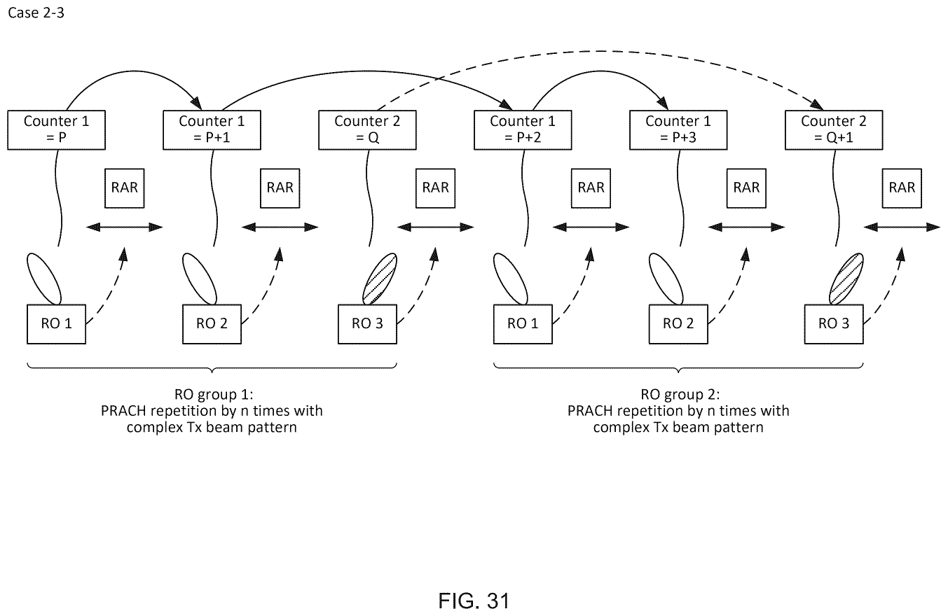

In the example of FIG. 31, the UE repeatedly transmits Msg1 using a composite beam pattern in one RO group, and transmission power increases by the ramping step at each transmission. For the beam directions, independent power ramping counters (beam-specific counters 1 and 2) are used, and power control is performed in each beam direction according to their own counters.

### SUPPLEMENTARY REMARKS

At least one operation of the above-described embodiment may be applied only to UEs that have reported a particular UE capability or support the particular UE capability.

The specific UE capability may indicate at least one of the following:
Supporting specific processing/operations/control/information for at least one of the above embodiments
Supporting a plurality of PRACH repetitions with the same beam
Supporting a plurality of PRACH repetitions with different beams
Supporting a plurality of PRACH transmissions with one Msg2 for a plurality of PRACH transmissions
Supporting a plurality of PRACH transmissions with one Msg2 for each PRACH transmission
Supporting individual preamble power ramping counters for a plurality of different beams for a plurality of PRACH transmissions
Supporting a common preamble power ramping counter for a plurality of different beams for a plurality of PRACH transmissions
Supporting preamble power ramping counters that are changed for each RO for a plurality of PRACH transmissions
Supporting preamble power ramping counters that are changed for each RO group for a plurality of PRACH transmissions
Supporting a new power increase step (ramping step) for a plurality of PRACH transmissions
Supporting explicit path loss RS configuration for a plurality of PRACH transmissions.

The above-described specific UE capability may be a capability that is applied across all frequencies (in common regardless of frequency), or may be a capability for each frequency (for example, cell, band, BWP), or may be a capability for each frequency range (for example, Frequency Range 1 (FR1), FR2, FR3, FR4, FR5, FR2-1, FR2-2), or may be a capability for each subcarrier spacing (SubCarrier Spacing (SCS)).

The specific UE capability may be a capability that is applied to all duplex modes (in common regardless of duplex mode), or may be a capability that is applied to only one duplex mode (for example, Time Division Duplex (TDD) or Frequency Division Duplex (FDD)).

At least one operation of the above-described embodiment may be applied when the UE is configured with specific information related to the above-described embodiment by higher layer signaling. For example, the specific information may be information indicating that at least one operation of the above-described embodiment is enabled, any RRC parameter for a specific release (for example, Rel. 18), and the like, or the like.

If the UE does not support at least one operation of the specific UE capability or is not configured with the specific information, Rel-15/16/17 operations may be applied to the UE, for example.

### Supplementary Note A

Regarding one embodiment of the present disclosure, the following supplementary notes of the invention will be given.

### Supplementary Note 1

A terminal including:

a control section that determines a plurality of groups including a plurality of resources for a physical random access channel, and determines transmission power for each of the plurality of resources by using one or more counters; and a transmitting section that transmits a plurality of repetitions of the physical random access channel in the plurality of resources.

### Supplementary Note 2

The terminal according to supplementary note 1, wherein the one or more counters are one counter common to a plurality of beams used for the plurality of resources.

### Supplementary Note 3

The terminal according to supplementary note 1, wherein the one or more counters are a plurality of counters for a plurality of respective beams used for the plurality of resources.

### Supplementary Note 4

The terminal according to any one of supplementary notes 1 to 3, wherein one or more steps for increasing the transmission power are configured for the one or more counters.

### Supplementary Note B

Regarding one embodiment of the present disclosure, the following supplementary notes of the invention will be given.

### Supplementary Note 1

A terminal including:
a control section that determines a plurality of groups including a plurality of resources for a physical random access channel, determines one or more pathloss reference signals for the plurality of groups, and determines a plurality of pieces of transmission power corresponding to the plurality of respective resources, based on the one or more pathloss reference signals; and
a transmitting section that transmits a plurality of repetitions of the physical random access channel in the plurality of resources.

### Supplementary Note 2

The terminal according to supplementary note 1, wherein the control section uses a plurality of beams for the plurality of repetitions.

### Supplementary Note 3

The terminal according to supplementary note 1 or 2, wherein the control section determines one pathloss reference signal for one group.

### Supplementary Note 4

The terminal according to supplementary note 1 or 2, wherein the control section determines a pathloss reference signal for each resource in one group.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

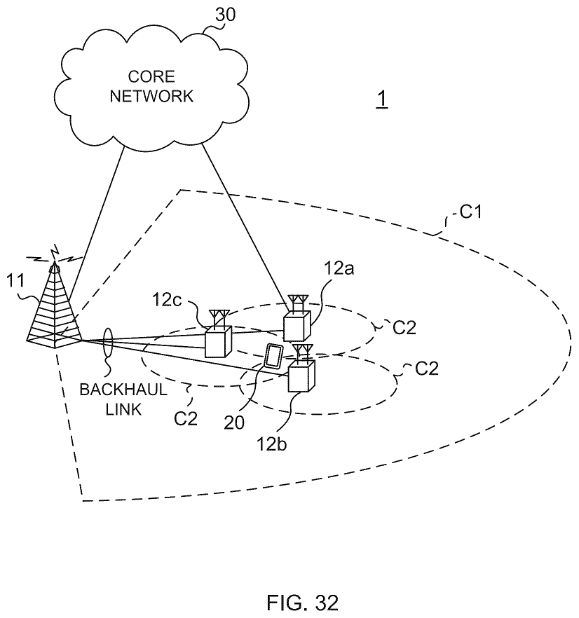

FIG. 32 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHZ), and FR2 may be a frequency band which is higher than 24 GHZ (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-S-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data,” and the PUSCH may be interpreted as “UL data.”

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

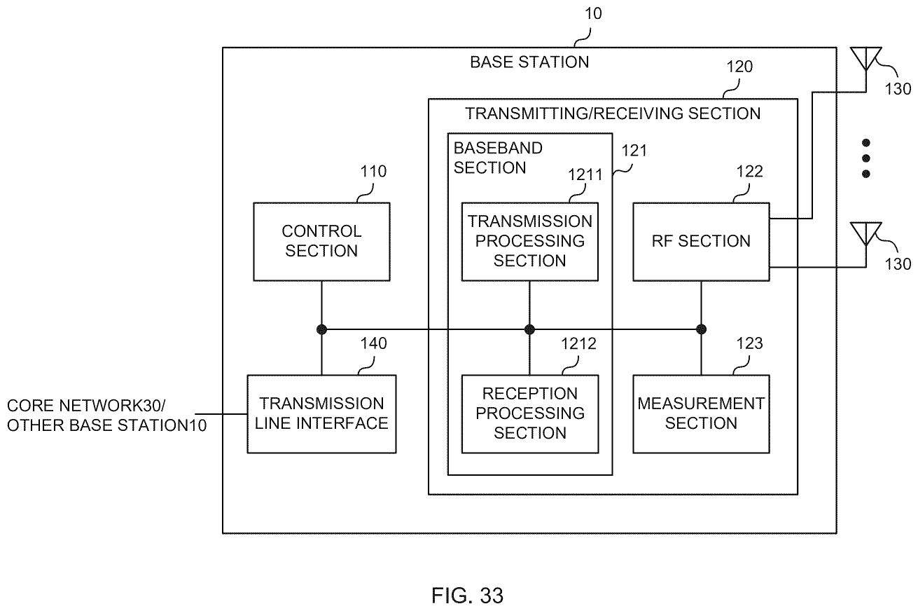

FIG. 33 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The control section 110 may control transmission of first information (for example, a common RACH configuration/a general RACH configuration/a configuration related to PRACH repetition) for determining a plurality of groups including a plurality of resources for a physical random access channel and transmission of second information (for example, a configuration of a ramping step) for determining transmission power for each of the plurality of resources by using one or more counters. The transmitting/receiving section 120 may receive a plurality of repetitions of the physical random access channel in the plurality of resources.

The control section 110 may control transmission of first information (for example, a common RACH configuration/a general RACH configuration/a configuration related to PRACH repetition) for determining a plurality of groups including a plurality of resources for a physical random access channel, and transmission of second information (for example, a configuration of a ramping step) for determining one or more pathloss reference signals for the plurality of groups and determining a plurality of pieces of transmission power corresponding to the plurality of respective resources, based on the one or more pathloss reference signals; and

The transmitting/receiving section 120 may receive a plurality of repetitions of the physical random access channel in the plurality of resources.

### (User Terminal)

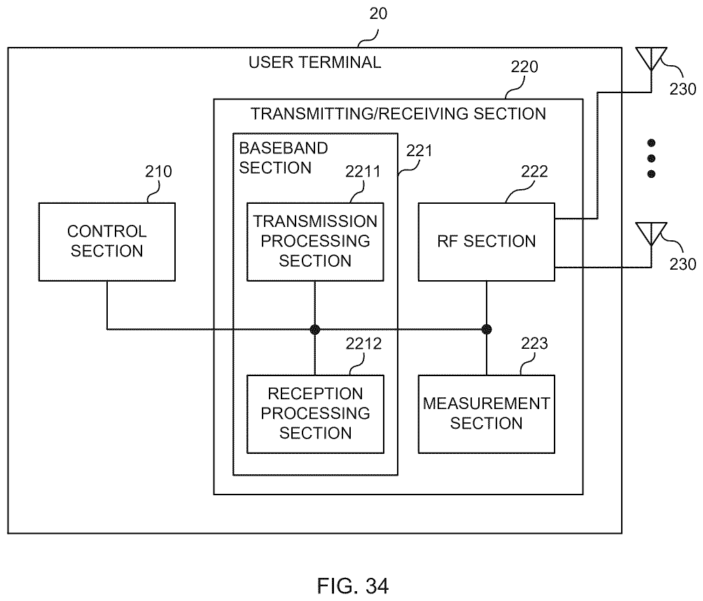

FIG. 34 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may determine a plurality of groups (for example, RO groups) including a plurality of resources (for example, ROs) for a physical random access channel, and determine transmission power for each of the plurality of resources by using one or more counters (for example,).

The transmitting/receiving section 220 may transmit a plurality of repetitions of the physical random access channel in the plurality of resources.

The one or more counters may be one counter common to a plurality of beams used for the plurality of resources.

The one or more counters may be a plurality of counters for a plurality of respective beams used for the plurality of resources.

One or more steps (for example, ramping step(s)) for increasing the transmission power may be configured for the one or more counters.

The control section 210 may determine a plurality of groups including a plurality of resources for a physical random access channel, determine one or more pathloss reference signals (for example, SSB(s)/CSI-RS(s)) for the plurality of groups, and determine a plurality of pieces of transmission power corresponding to the plurality of respective resources, based on the one or more pathloss reference signals. The transmitting/receiving section 220 may transmit a plurality of repetitions of the physical random access channel in the plurality of resources.

The control section 210 may use a plurality of beams for the plurality of repetitions.

The control section 210 may determine one pathloss reference signal for one group.

The control section 210 may determine a pathloss reference signal for each resource in one group.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

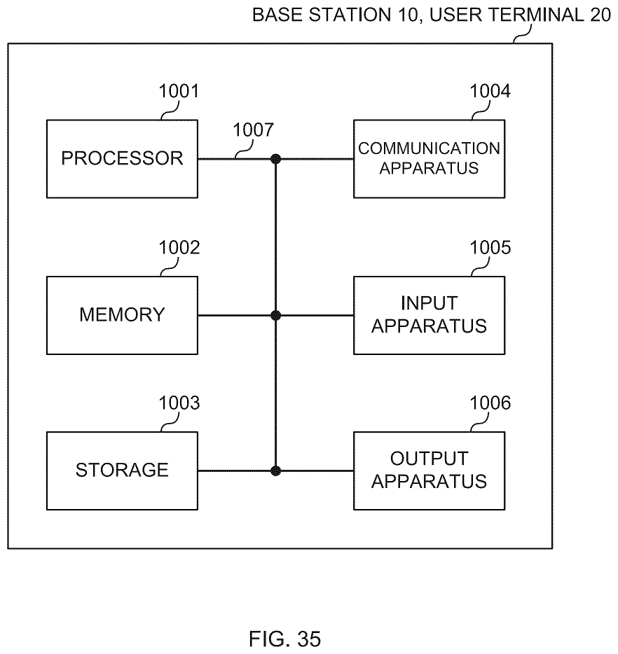

For example, a base station, a user terminal, and so on according to one embodiment of the present disclosure may function as a computer that executes the processes of the radio communication method of the present disclosure. FIG. 35 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIS.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB/RB group/set/pair,” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, a case that a base station transmits information to a terminal may be interpreted as a case that the base station indicates, for the terminal, control/operation based on the information, and vice versa.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

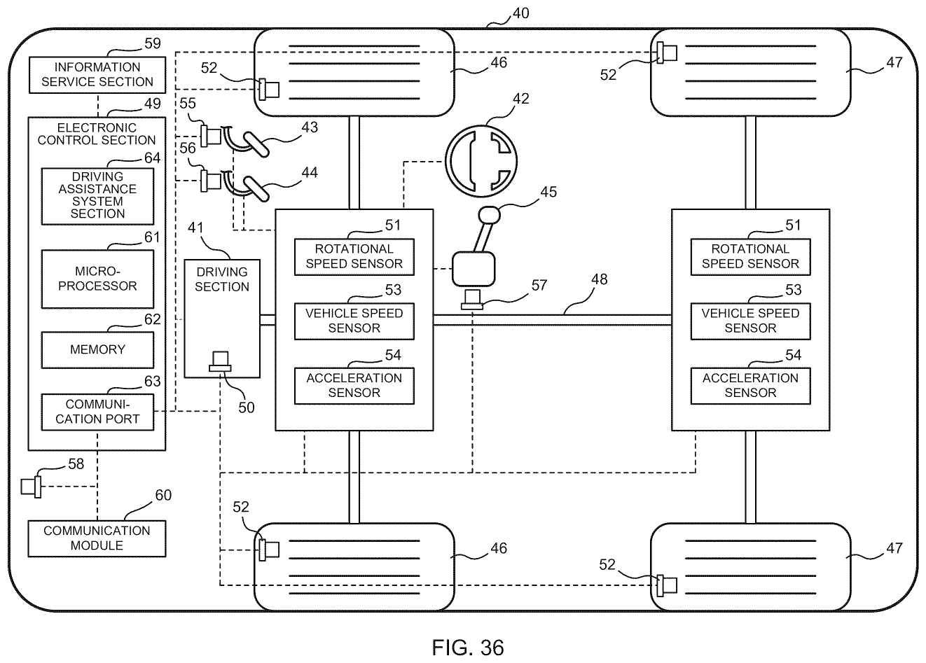

FIG. 36 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information such as drive information, traffic information, and entertainment information, such as a car navigation system, an audio system, a speaker, a display, a television, and a radio, and one or more ECUs that control these devices. The information service section 59 provides various pieces of information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUs that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the various pieces of information on the information service section 59 included in the vehicle.

The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may perform control of the driving section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B are each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

In the present disclosure, “equal to or smaller than,” “smaller than,” “equal to or larger than,” “larger than,” “equal to,” and the like may be interchangeably interpreted. In the present disclosure, words such as “good,” “poor,” “large,” “small,” “high,” “low,” “early,” “late,” “wide,” “narrow,” and the like may be interchangeably interpreted irrespective of positive degree, comparative degree, and superlative degree. In the present disclosure, expressions obtained by adding “i-th” (i is any integer) to words such as “good,” “poor,” “large,” “small,” “high,” “low,” “early,” “late,” “wide,” “narrow,” and the like may be interchangeably interpreted irrespective of positive degree, comparative degree, and superlative degree (for example, “highest” may be interpreted as “i-th highest,” and vice versa).

In the present disclosure, “of,” “for,” “regarding,” “related to,” “associated with,” and the like may be interchangeably interpreted.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a control section that determines a plurality of groups including a plurality of resources for a physical random access channel, and determines transmission power for each of the plurality of resources by using one or more counters; and
a transmitting section that transmits a plurality of repetitions of the physical random access channel in the plurality of resources.

2. The terminal according to claim 1, wherein
the one or more counters are one counter common to a plurality of beams used for the plurality of resources.

3. The terminal according to claim 1, wherein
the one or more counters are a plurality of counters for a plurality of respective beams used for the plurality of resources.

4. The terminal according to claim 1, wherein
one or more steps for increasing the transmission power are configured for the one or more counters.

5. A radio communication method for a terminal, the radio communication method comprising:
determining a plurality of groups including a plurality of resources for a physical random access channel and determining transmission power for each of the plurality of resources using one or more counters; and
transmitting a plurality of repetitions of the physical random access channel in the plurality of resources.

6. A base station comprising:
a control section that controls transmission of first information for determining a plurality of groups including a plurality of resources for a physical random access channel and transmission of second information for determining transmission power for each of the plurality of resources by using one or more counters; and
a receiving section that receives a plurality of repetitions of the physical random access channel in the plurality of resources.
